(19) United States
(12) Patent Application Publication
(10) Pub. No.: US 2026/0037317 A1
(43) Pub. Date: Feb. 5, 2026

(54) GPU COMPUTATIONAL RESOURCE SCHEDULING METHODS AND APPARATUSES

(71) Applicant: Alipay (Hangzhou) Information Technology Co., Ltd., Hangzhou (CN)

(72) Inventors: Rui Fang, Hangzhou (CN); Mingliang Gong, Hangzhou (CN); Ning Wang, Hangzhou (CN); Zhonghui Jiang, Hangzhou (CN); Junping Zhao, Hangzhou (CN); Tongkai Yang, Hangzhou (CN); Jiahao Gong, Hangzhou (CN); Xiaoyun Mao, Hangzhou (CN)

(73) Assignee: Alipay (Hangzhou) Information Technology Co., Ltd., Hangzhou (CN)

(21) Appl. No.: 18/976,512

(22) Filed: Dec. 11, 2024

(30) Foreign Application Priority Data
Jul. 31, 2024 (CN) 202411047342.9

(51) Int. Cl. G06F 9/50; G06F 9/30

(52) U.S. Cl. CPC G06F 9/5033; G06F 9/30189; G06F 9/5077

(57) ABSTRACT

This disclosure provides GPU computational resource scheduling methods and apparatuses. In an implementation, a method includes: in response to a target computing task created in a computing cluster, determining a task type of the target computing task. If the target computing task is a first-type computing task, scheduling, for running, the target computing task to a first GPU hardware that has remaining computational resources satisfying a computational demand of the target computing task in the computing cluster. In response to a first indication indicating that is reported by a first computing node integrated with the first GPU hardware and that indicates that the first-type computing task exclusively occupies computational resources of the first GPU hardware, rescheduling, for running to a second GPU hardware that has remaining computational resources satisfying a computational demand of the second-type computing task in the computing cluster.

### CROSS-REFERENCE TO RELATED APPLICATIONS

This application claims priority to Chinese Patent Application No. 202411047342.9, filed on Jul. 31, 2024, which is hereby incorporated by reference in its entirety.

### TECHNICAL FIELD

Embodiments of this specification relate to the field of artificial intelligence technologies, and in particular, to GPU computational resource scheduling methods and apparatuses.

### BACKGROUND

With rapid development of the AI field, a demand for computing power related to AI model training and reasoning has grown much faster than hardware development. As a core computational hardware widely used in AI scenarios, GPUs are facing issues of relative scarcity. In the context of a relative shortage of global GPU computational resources, GPUs have become valuable computational resources for organizations such as companies, institutions, and schools. However, there is still considerable waste of computational resources in the current usage of GPU hardware.

### SUMMARY

This specification provides a GPU computational resource scheduling method, applied to a scheduler corresponding to a computing cluster. At least some computing nodes in the computing cluster are integrated with at least one GPU hardware, the computing node supports running of a plurality of types of computing tasks on a same integrated GPU hardware, the plurality of types of computing tasks include a first-type computing task and a second-type computing task, a service level of the first-type computing task is higher than that of the second-type computing task, and the method includes: in response to a target computing task created in the computing cluster, determining a task type of the target computing task; scheduling the target computing task to a first GPU hardware in the computing cluster for running if the target computing task is the first-type computing task, where the first GPU hardware is a GPU hardware that has remaining computational resources satisfying a computational demand of the target computing task; and in response to a first indication reported by a first computing node, rescheduling, to a second GPU hardware in the computing cluster for running, the second-type computing task that is scheduled to the first GPU hardware for running, where the first computing node is a computing node integrated with the first GPU hardware, the first indication is used to indicate that the first-type computing task exclusively occupies computational resources of the first GPU hardware, the first indication is reported by the first computing node to the scheduler when computational resources of the first GPU hardware that are occupied by the first-type computing task reach a preset threshold, and the second GPU hardware is a GPU hardware that has remaining computational resources satisfying a computational demand of the second-type computing task.

Optionally, the method further includes: scheduling the target computing task to a third GPU hardware in the computing cluster for running if the target computing task is the second-type computing task, where the third GPU hardware is a GPU hardware that has computational resources not exclusively occupied by the first-type computing task and that has remaining computational resources satisfying the computational demand of the target computing task.

Optionally, the scheduler maintains a hardware mode corresponding to each GPU hardware in the computing cluster. The hardware mode includes a resource sharing mode and a resource exclusive mode, the resource sharing mode indicates that computational resources of the GPU hardware support running of a plurality of types of computing tasks, and the resource exclusive mode indicates that the computational resources of the GPU hardware are only used to execute the first-type computing task.

Optionally, the method further includes: switching the first GPU hardware from the resource sharing mode to the resource exclusive mode in response to the first indication reported by the first computing node integrated with the first GPU hardware; and the scheduling the target computing task to a third GPU hardware in the computing cluster for running if the target computing task is the second-type computing task includes: scheduling the target computing task to the third GPU hardware in the computing cluster for running if the target computing task is the second-type computing task, where the third GPU hardware is a GPU hardware that is in the resource sharing mode and that has remaining computational resources satisfying the computational demand of the target computing task.

Optionally, the method further includes: switching the first GPU hardware from the resource exclusive mode to the resource sharing mode in response to a second instruction of the first computing node, where the second instruction is reported by the first computing node to the scheduler when the computational resources of the first GPU hardware that are occupied by the first-type computing task are less than a preset threshold.

Optionally, the computing node supports virtualizing computational resources of an integrated GPU hardware into a virtual GPU, the virtual GPU includes a first-type virtual GPU configured to execute the first-type computing task and a second-type virtual GPU configured to execute the second-type computing task.

Optionally, the scheduler maintains a first remaining computational capacity and a second remaining computational capacity that correspond to each GPU hardware in the computing cluster, the first remaining computational capacity represents a quantity of first-type virtual GPUs that are capable of being created based on the remaining computational resources of the GPU hardware, and the second remaining computational capacity represents a quantity of second-type virtual GPUs that are capable of being created based on the remaining computational resources of the GPU hardware; the scheduling the target computing task to a first GPU hardware in the computing cluster for running if the target computing task is the first-type computing task includes: if the target computing task is the first-type computing task, determining, from the computing cluster based on the maintained first remaining computational capacity corresponding to each GPU hardware, the first GPU hardware that has first remaining computational capacity satisfying a first demand of the target computing task for the first-type virtual GPU, and scheduling the target computing task to the first GPU hardware in the computing cluster for running; and the scheduling the target computing task to a third GPU hardware in the computing cluster for running if the target computing task is the second-type computing task includes: if the target computing task is the second-type computing task, determining, from the computing cluster based on the maintained second remaining computational capacity corresponding to each GPU hardware, the third GPU hardware that has computational resources not exclusively occupied by the first-type computing task and that has second remaining computational capacity satisfying a second demand of the target computing task for the second-type virtual GPU, and scheduling the target computing task to the third GPU hardware in the computing cluster for running.

Optionally, the scheduling the target computing task to a first GPU hardware in the computing cluster for running includes: sending the first demand of the target computing task for the first-type virtual GPU and a hardware identifier of the first GPU hardware to the first computing node integrated with the first GPU hardware, so that the first computing node virtualizes the first GPU hardware to obtain several first-type virtual GPUs corresponding to the first demand, and runs the target computing task based on the several first-type virtual GPUs; and the scheduling the target computing task to a third GPU hardware in the computing cluster for running includes: sending the second demand of the target computing task for the second-type virtual GPU and a hardware identifier of the third GPU hardware to a second computing node integrated with the third GPU hardware, so that the second computing node virtualizes the third GPU hardware to obtain several second-type virtual GPUs corresponding to the second demand, and runs the target computing task based on the several second-type virtual GPUs.

Optionally, the scheduler maintains a global topology corresponding to all the computing nodes in the computing cluster, and the global topology is a topology including topology information reported by all the computing nodes in the computing cluster; the sending the first demand of the target computing task for the first-type virtual GPU and a hardware identifier of the first GPU hardware to the first computing node integrated with the first GPU hardware includes: querying the global topology, determining the first computing node integrated with the first GPU hardware, and sending the first demand of the target computing task for the first-type virtual GPU and the hardware identifier of the first GPU hardware to the first computing node; and the sending the second demand of the target computing task for the second-type virtual GPU and a hardware identifier of the third GPU hardware to a second computing node integrated with the third GPU hardware includes: querying the global topology, determining the second computing node integrated with the third GPU hardware, and sending the second demand of the target computing task for the second-type virtual GPU and the hardware identifier of the third GPU hardware to the second computing node.

Optionally, the method further includes: obtaining an initial value of the first remaining computational capacity and an initial value of the second remaining computational capacity that are reported by each computing node in the computing cluster when joining the computing cluster, locally maintaining the obtained initial value of the first remaining computational capacity and the obtained initial value of the second remaining computational capacity, and in response to that the first-type computing task or the second-type computing task that is created in the computing cluster is scheduled to any GPU hardware in the computing cluster, based on a quantity of first-type computing tasks or a quantity of second-type computing tasks that are occupied by the first-type computing task or the second-type computing task, updating the maintained initial value of the first remaining computational capacity or the maintained initial value of the second remaining computational capacity of the GPU hardware; or obtaining the first remaining computational capacity and the second remaining computational capacity that are reported in real time by each computing node in the computing cluster, and locally maintaining the obtained first remaining computational capacity and the obtained second remaining computational capacity, where the first remaining computational capacity and the second remaining computational capacity that are reported in real time by each computing node are obtained by updating an initial value of the first remaining computational capacity and an initial value of the second remaining computational capacity by each computing node based on a quantity of first-type virtual GPUs and a quantity of second-type virtual GPUs that are occupied by the first-type computing task or the second-type computing task that is scheduled to a GPU hardware integrated into the computing node for running.

Optionally, the second GPU hardware includes a GPU hardware, other than the first GPU hardware, that is integrated into the first computing node and that has remaining computational resources satisfying the computational demand of the second-type computing task, or the second GPU hardware includes a GPU hardware that is integrated into another computing node different from the first computing node in the computing cluster and that has remaining computational resources satisfying the computational demand of the second-type computing task; and the rescheduling, to a second GPU hardware for running, the second-type computing task that is scheduled to the first GPU hardware for running includes: determining whether a second GPU hardware that has remaining computational resources satisfying the computational demand of the second-type computing task that is scheduled to the first GPU hardware for running exists in another GPU hardware that is different from the first GPU hardware and that is integrated into the first computing node; and further scheduling the second-type computing task to the second GPU hardware for running if the second GPU hardware exists in the another GPU hardware; or if the second GPU hardware does not exist in the another GPU hardware, determining whether a second GPU that has remaining computational resources satisfying the computational demand of the second-type computing task exists in a GPU hardware integrated into another computing node different from the first computing node in the computing cluster; and further scheduling the second-type computing task to the second GPU hardware for running if the second GPU hardware exists.

Optionally, the computing cluster is a kubernetes cluster, the computing node supports hybrid deployment, on a same integrated GPU hardware, of a plurality of containers for running different types of computing tasks, and the computing task is a computing task running in a container deployed on each GPU hardware in the kubernetes cluster.

Optionally, the first-type computing task is a computing task running in a container that has a QoS service level that is Guaranteed, and the second-type computing task is a computing task running in a container that has a QoS service level that is BestEffort.

This specification further provides a GPU computational resource scheduling method, applied to any computing node in a computing cluster. At least some computing nodes in the computing cluster are integrated with at least one GPU hardware, the computing node supports running of a plurality of types of computing tasks on a same integrated GPU hardware, the plurality of types of computing tasks include a first-type computing task and a second-type computing task, a service level of the first-type computing task is higher than that of the second-type computing task, and the method includes: in response to that a scheduler corresponding to the computing cluster schedules the first-type computing task to a first GPU hardware integrated into the computing node, running the first-type computing task on the first GPU hardware, where the first-type computing task is scheduled by the scheduler to the computing node when it is determined that remaining computational resources of the first GPU hardware satisfy a computational demand of the first-type computing task; determining whether computational resources of the first GPU hardware that are occupied by the first-type computing task reach a preset threshold; and reporting a first indication to the scheduler if the computational resources of the first GPU hardware that are occupied by the first-type computing task reach the preset threshold, where the first indication is used to indicate that the first-type computing task exclusively occupies computational resources of the first GPU hardware, so that the scheduler reschedules, to a second GPU hardware in the computing cluster for running, the second-type computing task that is scheduled to the first GPU hardware for running, and the second GPU hardware is a GPU hardware that has remaining computational resources satisfying a computational demand of the second-type computing task.

Optionally, the determining whether computational resources of the first GPU hardware that are occupied by the first-type computing task reach a preset threshold includes: determining whether a value of a computing power index related to the computational resources of the first GPU hardware that are occupied by the first-type computing task reach the preset threshold, where the computing power index includes any one or a combination of a plurality of indexes of the following indexes: response duration of a request related to the first-type computing task, utilization of the first GPU hardware, and utilization of graphics memory of the first GPU hardware; and if the value of the computing power index reaches the preset threshold, determining that the computational resources of the first GPU hardware that are occupied by the first-type computing task reach the preset threshold.

Optionally, the computing node supports virtualizing computational resources of an integrated GPU hardware into a virtual GPU, the virtual GPU includes a first-type virtual GPU configured to execute the first-type computing task and a second-type virtual GPU configured to execute the second-type computing task; and the method further includes: in response to that the computing node joins the computing cluster, reporting, to the scheduler, an initial value of the first remaining computational capacity and an initial value of the second remaining computational capacity that correspond to the GPU hardware integrated into the computing node, so that the scheduler performs local maintenance, where the first remaining computational capacity represents a quantity of first-type virtual GPUs that are capable of being created based on remaining computational resources of the GPU hardware, and the second remaining computational capacity represents a quantity of second-type virtual GPUs that are capable of being created based on the remaining computational resources of the GPU hardware; or obtaining a quantity of first-type virtual GPUs or a quantity of second-type virtual GPUs that are occupied by the first-type computing task or the second-type computing task that are scheduled by the scheduler to the GPU hardware integrated into the computing node for running; further updating, based on the obtained quantity of first-type virtual GPUs or the obtained quantity of second-type virtual GPUs, the initial value of the first remaining computational capacity and the initial value of the second remaining computational capacity that correspond to the GPU hardware integrated into the computing node; and reporting the updated first remaining computational capacity and the updated second remaining computational capacity to the scheduler in real time, so that the scheduler performs local maintenance.

Optionally, the second GPU hardware includes a GPU hardware, other than the first GPU hardware, that is integrated into the first computing node and that has remaining computational resources satisfying the computational demand of the second-type computing task, or the second GPU hardware includes a GPU hardware that is integrated into another computing node different from the first computing node in the computing cluster and that has remaining computational resources satisfying the computational demand of the second-type computing task.

Optionally, the target computing cluster is a kubernetes cluster, the computing node supports hybrid deployment, on an integrated same GPU hardware, of a plurality of containers for running different types of computing tasks, and the computing task is a computing task running in the container.

Optionally, the first-type computing task is a computing task running in a container that has a QoS service level that is Guaranteed, and the second-type computing task is a computing task running in a container that has a QoS service level that is BestEffort.

This specification further provides a GPU computational resource scheduling apparatus, applied to a scheduler corresponding to a computing cluster. At least some computing nodes in the computing cluster are integrated with at least one GPU hardware, the computing node supports running of a plurality of types of computing tasks on a same integrated GPU hardware, the plurality of types of computing tasks include a first-type computing task and a second-type computing task, a service level of the first-type computing task is higher than that of the second-type computing task, and the apparatus includes: a first determining module, configured to: in response to a target computing task created in the computing cluster, determine a task type of the target computing task; and a scheduling module, configured to: schedule the target computing task to a first GPU hardware in the computing cluster for running if the target computing task is the first-type computing task, where the first GPU hardware is a GPU hardware that has remaining computational resources satisfying a computational demand of the target computing task; and in response to a first indication reported by a first computing node, reschedule, to a second GPU hardware in the computing cluster for running, the second-type computing task that is scheduled to the first GPU hardware for running, where the first computing node is a computing node integrated with the first GPU hardware, the first indication is used to indicate that the first-type computing task exclusively occupies computational resources of the first GPU hardware, the first indication is reported by the first computing node to the scheduler when computational resources of the first GPU hardware that are occupied by the first-type computing task reach a preset threshold, and the second GPU hardware is GPU hardware that has remaining computational resources satisfying a computational demand of the second-type computing task.

This specification further provides a GPU computational resource scheduling apparatus, applied to any computing node in a computing cluster. At least some computing nodes in the computing cluster are integrated with at least one GPU hardware, the computing node supports running of a plurality of types of computing tasks on a same integrated GPU hardware, the plurality of types of computing tasks include a first-type computing task and a second-type computing task, a service level of the first-type computing task is higher than that of the second-type computing task, and the apparatus includes: a running module, configured to: in response to that a scheduler corresponding to the computing cluster schedules the first-type computing task to a first GPU hardware integrated into the computing node, run the first-type computing task on the first GPU hardware, where the first-type computing task is scheduled by the scheduler to the computing node when it is determined that remaining computational resources of the first GPU hardware satisfy a computational demand of the first-type computing task; a second determining module, configured to determine whether computational resources of the first GPU hardware that are occupied by the first-type computing task reach a preset threshold; and a reporting module, configured to report a first indication to the scheduler if the computational resources of the first GPU hardware that are occupied by the first-type computing task reach the preset threshold, where the first indication is used to indicate that the first-type computing task exclusively occupies computational resources of the first GPU hardware, so that the scheduler reschedules, to a second GPU hardware in the computing cluster for running, the second-type computing task that is scheduled to the first GPU hardware for running, and the second GPU hardware is a GPU hardware that has remaining computational resources satisfying a computational demand of the second-type computing task.

In the above-mentioned technical solutions, the plurality of types of computing tasks are supported to run on the same GPU hardware integrated into the computing node in the computing cluster, so that the scheduler of the computing cluster can schedule, to the same GPU hardware for running, the plurality of types of computing tasks created in the computing cluster, thereby improving utilization of computational resources of the GPU.

In addition, when it is determined that computational resources of a specific GPU hardware that are occupied by a first-type computing task that has a relatively high service level and that is scheduled to the GPU hardware reach a preset threshold, a second type that is scheduled to the GPU hardware and that has a service level lower than that of the first-type computing task is rescheduled to another GPU hardware in the computing cluster for running, so that the second-type computing task is elastically scheduled on the basis of that the GPU hardware simultaneously supports running of a plurality of types of computing tasks. In this way, when the computational resources of the GPU hardware that are occupied by the first-type computing task reach a certain degree, it can be ensured that the first-type computing task can exclusively occupy computational resources of the GPU hardware, and the second-type computing task can be scheduled to the another GPU hardware for normal running, so that the first-type computing task and the second-type computing task can more properly share the computational resources of the GPU, to reduce interference between tasks that is generated in a process in which different types of tasks share the computational resources of the GPU hardware.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following descriptions show merely some embodiments recorded in this specification, and a person of ordinary skill in the art can still derive other drawings from these accompanying drawings without creative efforts.

FIG. 1 is a flowchart illustrating a GPU computational resource scheduling method, according to one or more embodiments of this specification;

FIG. 2 is a flowchart illustrating another GPU computational resource scheduling method, according to one or more embodiments of this specification;

FIG. 3 is a schematic diagram illustrating scheduling of computational resources of a GPU hardware integrated into a computing node in a kubernetes cluster, according to one or more embodiments of this specification;

FIG. 4 is a schematic diagram illustrating elastic scheduling of a computing task that is scheduled to a GPU hardware integrated into a computing node and that has a low service level in a kubernetes cluster, according to one or more embodiments of this specification;

FIG. 5 is a schematic structural diagram illustrating an electronic device, according to one or more embodiments of this specification;

FIG. 6 is a block diagram illustrating a GPU computational resource scheduling apparatus, according to one or more embodiments of this specification; and

FIG. 7 is a block diagram illustrating another GPU computational resource scheduling apparatus, according to one or more embodiments of this specification.

### DESCRIPTION OF EMBODIMENTS

To make a person skilled in the art better understand the technical solutions in this specification, the following clearly and completely describes the technical solutions in the embodiments of this specification with reference to the accompanying drawings in the embodiments of this specification. Clearly, the described embodiments are merely some but not all of the embodiments of this specification. All other embodiments obtained by a person of ordinary skill in the art based on the embodiments of this specification without creative efforts shall fall within the protection scope of this specification.

In the large context of the relative shortage of GPU computational resources, GPUs have become valuable computational resources. However, currently, for use of a GPU hardware, a relatively large quantity of capability resources are still wasted.

For example, a reasoning task of an AI model is executed by using the GPU. In such a reasoning scenario, use of the GPU can have an obvious tidal phenomenon. That is, when a reasoning task needs to be executed, utilization of the GPU is relatively high. When no reasoning task needs to be executed, utilization of the GPU is relatively low. In this case, a large quantity of computational resources are in an idle state. Consequently, a large quantity of computational resources are wasted.

To fully use computational resources of the GPU, in actual applications, computational resources of a physical GPU hardware can be virtualized into a plurality of virtual GPUs based on a virtualization technology, and then computational resources of the plurality of virtual GPUs can be respectively allocated to different types of computing tasks, so that the different types of computing tasks can share the computational resources of the same GPU hardware, and run on the same GPU hardware.

However, in actual applications, the plurality of types of computing tasks running on the same GPU hardware usually may have different service levels, and the service levels of the computing tasks may not be ensured by simply virtualizing the GPU hardware.

For example, it is assumed that the plurality of types of computing tasks include a first-type computing task and a second-type computing task that has service level lower than that of a first-type task. In a related technology, when the first-type computing task and the second-type computing task run on the same GPU hardware, computational resources are usually scheduled for the first-type computing task and the second-type computing task from a perspective of sharing computational resources of a single physical GPU.

In one case, after the first-type computing task is scheduled to a specific GPU hardware integrated into a specific computing node, if the first-type computing task needs to occupy a relatively large quantity of virtual GPU computational resources in a virtual GPU obtained by virtualizing the GPU hardware, and the second-type computing task has run on the GPU hardware, running of the second-type computing task can usually be interrupted, and when computational resources of the virtual GPU that are occupied by the first-type computing task fall, a virtual GPU is reallocated to the second-type computing task from an idle virtual GPU.

However, in this case, the second-type computing task may always be in a hungry state because the first-type computing task continuously occupies a relatively large quantity of computational resources of the virtual GPU, and cannot obtain the computational resources of the GPU hardware.

In another case, virtual GPUs can alternatively be allocated, through static division, to the first-type computing task and the second-type computing task from the virtual GPUs obtained by virtualizing the GPU hardware. For example, some of the virtual GPUs can be reserved for the first-type computing task and the second-type computing task from these virtual GPUs.

However, in this case, because of static division, the first-type computing task and the second-type computing task cannot share a virtual GPU allocated to the first-type computing task and the second-type computing task. In this case, if an idle virtual GPU exists in virtual GPUs reserved for the first-type computing task, the idle virtual GPU cannot be re-allocated to the second-type computing task for use, thereby causing low utilization of the computational resources of the GPU hardware.

In addition, some of the virtual GPUs need to be reserved for the second-type computing task. If the first-type computing task with the high service level is a computing task that has a demand that user experience of exclusively occupying the computational resources of the GPU hardware can be provided for a user. In this case, a service level of the second-type computing task cannot be ensured.

It can be learned that, from a perspective of sharing the computational resources of the single physical GPU, computational resources are scheduled for the first-type computing task and the second-type computing task. Clearly, the first-type computing task and the second-type computing task improperly occupy the computational resources of GPU hardware, and the service levels of the computing tasks cannot be ensured.

Based on this, from a perspective of sharing computational resources of each physical GPU in a computing cluster, this specification provides a technical solution for elastically scheduling a computing task with a low service level in a plurality of types of computing tasks in an application scenario in which the same GPU hardware supports running of the plurality of types of computing tasks.

In this technical solution, a scheduler corresponding to the computing cluster can determine a task type of a target computing task when the target computing task is created in the computing cluster. If the target computing task is a first-type computing task with a relatively high service level, the target computing task can be scheduled to a first GPU hardware that has remaining computational resources satisfying a computational demand of the target computing task in the computing cluster.

A computing node integrated with the first GPU hardware can determine, in a process in which the target computing task runs on the first GPU hardware, whether computational resources of the first GPU hardware that are occupied by the first-type computing task running on the first GPU hardware reach a preset threshold. If the computational resources of the first GPU hardware that are occupied by the first-type computing task running on the first GPU reach the preset threshold, a first indication indicating that the first-type computing task exclusively occupies computational resources of the first GPU hardware can be reported to the scheduler.

After receiving the first indication, the scheduler can reschedule, to the second-type GPU hardware that has remaining computational resources satisfying the computational demand of the second-type computing task in the computing cluster, the second-type computing task that is scheduled to the first GPU hardware for running.

In the above-mentioned technical solutions, the plurality of types of computing tasks are supported to run on the same GPU hardware integrated into the computing node in the computing cluster, so that the scheduler of the computing cluster can schedule, to the same GPU hardware for running, the plurality of types of computing tasks created in the computing cluster, thereby improving utilization of computational resources of the GPU.

In addition, when it is determined that computational resources of a specific GPU hardware that are occupied by a first-type computing task that has a relatively high service level and that is scheduled to the GPU hardware reach a preset threshold, a second type that is scheduled to the GPU hardware and that has a service level lower than that of the first-type computing task is rescheduled to another GPU hardware in the computing cluster for running, so that the second-type computing task is elastically scheduled on the basis of that the GPU hardware simultaneously supports running of a plurality of types of computing tasks. In this way, when the computational resources of the GPU hardware that are occupied by the first-type computing task reach a certain degree, it can be ensured that the first-type computing task can exclusively occupy computational resources of the GPU hardware, and the second-type computing task can be scheduled to the another GPU hardware for normal running, so that the first-type computing task and the second-type computing task can more properly share the computational resources of the GPU, to reduce interference between tasks that is generated in a process in which different types of tasks share the computational resources of the GPU hardware.

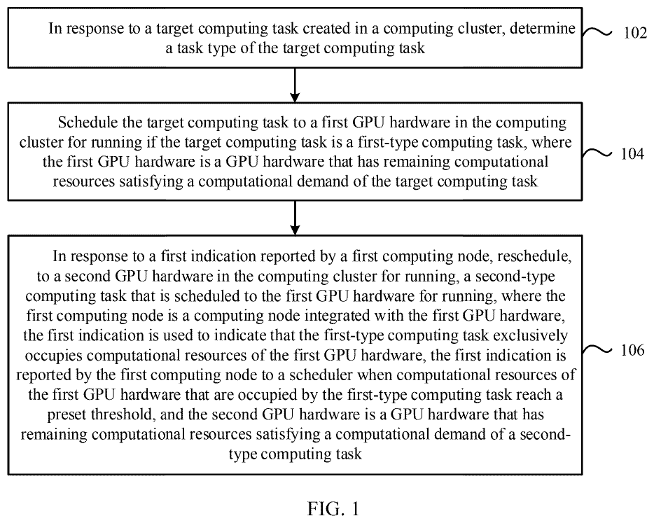

FIG. 1 is a flowchart illustrating a GPU computational resource scheduling method, according to this specification. The method is applied to a scheduler corresponding to a computing cluster. At least some computing nodes in the computing cluster are integrated with at least one GPU hardware, the computing node supports running of a plurality of types of computing tasks on a same integrated GPU hardware, the plurality of types of computing tasks include a first-type computing task and a second-type computing task, a service level of the first-type computing task is higher than that of the second-type computing task, and the method includes the following execution process:

Step 102: In response to a target computing task created in the computing cluster, determine a task type of the target computing task.

The computing cluster can include several computing nodes. At least some of the computing nodes each can be integrated with at least one GPU hardware, and can run a computing task by using the integrated GPU hardware.

The computing task can include a task that supports to be run based on computational resources of the GPU hardware. For example, the computing task can be a training or reasoning task related to a large language model (LLM) model.

In actual application, the scheduler can be further deployed for the computing cluster. The scheduler can be specifically configured to: manage the computational resources of GPU hardware integrated into each computing node in the computing cluster, and properly schedule the created computing task in the computing cluster based on a remaining status of the computational resources of the GPU hardware integrated into each computing node in the computing cluster.

For example, in an example, the computing cluster can be a kubernetes cluster, and a computing node in the kubernetes cluster can be a physical machine or a virtual machine. In the kubernetes cluster that is a distributed cluster created based on a container technology, the computing task can usually run on each computing node in a form of a containerized application. That is, the computing task can be understood as a computing task running in a container deployed on each node computing node in the kubernetes cluster.

A smallest unit of managing the container in the kubernetes cluster is referred to as a pod. One pod includes one or more containers, and usually represents a process running in the kubernetes cluster. When the containerized application (namely, the computing task) is deployed in the kubernetes cluster, a pod can be usually created for the containerized application, and execution code related to the containerized application is encapsulated into the pod in a form of a container image. Then, a scheduler of the kubernetes cluster can schedule, based on the remaining status of the computational resources of the GPU hardware integrated into each computing node, the pod to a GPU hardware integrated into a specific computing node in the computing cluster, and deploy the pod on the GPU hardware, so that the containerized application encapsulated in the pod can be run based on the computational resources of the GPU hardware.

It should be noted that, in actual applications, the scheduler can be specifically an independent service device interconnected with the computing cluster, or can be a computing node selected from the computing cluster as the scheduler. This is not specifically limited in this specification.

To fully use the computational resources of the GPU hardware integrated into the computing node, the computing node integrated with the GPU hardware in the computing cluster can further support running of the plurality of types of computing tasks on the same integrated GPU hardware. The plurality of types of computing tasks can specifically include the first-type computing task and the second-type computing task.

For example, in an example, that the computing cluster is a kubernetes cluster is still used as an example. To fully use the computational resources of the integrated GPU hardware, the computing node in the kubernetes cluster can support hybrid deployment, on the same integrated GPU hardware, of a plurality of containers for running different types of computing tasks. In this case, the computing task can be a computing task running in a container deployed on the GPU hardware integrated into the computing node in the kubernetes cluster.

The first-type computing task can be a corresponding computing task with a relatively high service level. For example, the first-type computing task can be a computing task that has a demand that user experience of exclusively occupying the computational resources of the GPU hardware can be provided for a user. The second-type computing task can be a computing task that has a service level lower than that of the first-type computing task.

It should be noted that, in actual applications, the service level can be specifically a service level promised by a service provider to the user based on a service-level agreement (SLA).

For example, in an example, that the computing cluster is a kubernetes cluster is still used as an example. In the kubernetes cluster that is a distributed cluster created based on the container technology, a computing node can usually support hybrid deployment of a plurality of containers with different quality of service (QoS) priorities on the same integrated GPU hardware. In this scenario, a service level can be set for the containerized application (namely, the computing task) created in the cluster based on a QoS mechanism for the container.

The QoS mechanism for the container in the kubernetes cluster is a resource management policy for the pod (namely, the container) in the kubernetes cluster. Resources can be properly allocated to the pod based on a resource request and a limit of the pod, so that resources used by the pod in the cluster can be properly controlled.

Based on the QoS mechanism of the kubernetes cluster, pods can be classified into three QoS levels: Guaranteed, Burstable, and BestEffort based on the resource request and the limit of the pods.

For a pod that has a QoS level that is Guaranteed, such pods declare equal resource requests and resource limits. It means that the pod obtains all resources requested by the pod and such a quantity is not exceeded. Guaranteed pod has the highest priority in terms resource allocation. For a pod that has a QoS level that is Guaranteed, the cluster can provide a determined resource guarantee for the pod, and this is suitable for an application whose running does not have a strict demand for resources.

For a pod that has a QoS level that is Burstable, a quantity of resources requested by such a pod are less than a limit set by the pod. This means that when the resources are sufficient, the pod can use more resources than those requested by the pod. However, in a case of a resource shortage, resources used by the pod is limited to a requested resource range. For a pod that has a QoS level that is Burstable, the cluster elastically and flexibly provides resources for such a pod. Such a pod is usually allowed to borrow additional resources when resources in the cluster allows, and this is suitable for an application that does not need to run with full load in most time, but may need additional resources in a peak time period.

For a pod that has a QoS level that is BestEffort, such a pod has no explicit resource request or limit, and this means that such a pod uses idle resources, on a node, that is not used by another pod. Such a pod has the lowest priority in terms of resource allocation, and is the first sacrificed object in a case of a resource shortage, to ensure resource demands of pods that have QoS levels that is Guaranteed and Burstable. Such a pod is usually suitable for an application whose running is insensitive to a resource demand.

It can be easily understood that the pod that has a QoS level that is Guaranteed can usually have the highest service level, and the pod that has a QoS level that is BestEffort usually has the lowest service level. In this case, the first-type computing task can be a computing task run by the pod that has a QoS service level that is Guaranteed. Correspondingly, the second-type computing task can be a computing task run by the pod that has a QoS service level that is BestEffort. It should be noted that, because the technical solution in this specification aims to implement elastic scheduling of the second-type computing task, for the pod that has a QoS level that is Burstable, when the cluster provides resources for such a pod, the cluster has is clastic and flexible. Therefore, in this specification, the pod that has a QoS level that is BestEffort can be used as the second-type computing task, and a computing task running by the pod that has a QoS level that is Burstable does not need to be used as the second-type computing task.

Certainly, when the computing cluster is the kubernetes cluster, a service level can be set, based on the QoS mechanism for the container, for the containerized application created in the cluster, or a service level can be set, in another manner, for the containerized application created in the cluster. Manners are not listed in this specification.

In this specification, when the user creates the target computing task in the computing cluster based on a specific computing demand, the scheduler of the computing cluster can determine a task type of the target computing task in response to the target computing task.

Specifically, the scheduler can determine, based on the service level set by the user for the target computing task, that the target computing task is the first-type computing task with a higher service level or the second-type computing task with a lower service level.

For example, the computing cluster is still a kubernetes cluster, the first-type computing task is a computing task run by the pod that has a QoS service level that is Guaranteed, and the second-type computing task is a computing task run by the pod that has a QoS service level that is BestEffort. When the user creates a new pod (namely, the target computing task) in the computing cluster based on the specific computing demand, and when the scheduler determines the task type of the computing task run by the pod, the scheduler can specifically determine the QoS service level of the pod. If the QoS service level of the pod is Guaranteed, it indicates that a computing task run by the pod is the first-type computing task. If the QoS service level of the pod is BestEffort, it indicates that a computing task run by the pod is the second-type computing task.

Step 104: If the target computing task is the first-type computing task, schedule, for running, the target computing task to a first GPU hardware that has remaining computational resources satisfying a computational demand of the target computing task in the computing cluster.

In this specification, to enable the first-type computing task and the second-type computing task to more properly share the computational resources of the same GPU hardware, when the scheduler in the computing cluster schedules the first-type computing task and the second-type computing task, the scheduler can no longer schedule computational resources for the first-type computing task and the second-type computing task from a perspective of sharing the computational resources of the single physical GPU hardware; instead, can schedule computational resources for the first-type computing task and the second-type computing task from a perspective of sharing the computational resources of each physical GPU hardware in the computing cluster.

When the computational resources are scheduled from a perspective of sharing the computational resources of each physical GPU hardware in the computing cluster, the scheduler can pre-maintain the remaining status of the computational resources of each GPU hardware in the computing cluster, so that the remaining status of the computational resources of all the GPU hardwares in the computing cluster can be determined from a global perspective.

After the scheduler determines the task type of the target computing task, if the target computing task is the first-type computing task, the scheduler can determine, for the target computing task from each physical GPU hardware in the computing cluster with reference to the maintained remaining status of the computational resources of each GPU hardware, the first GPU hardware that has remaining computational resources satisfying the computational demand of the target computing task.

For example, in actual applications, with reference to the maintained remaining status of the computational resources of each GPU hardware, the scheduler can specifically determine, from the computing cluster, a computing node that has remaining computational resources satisfying the computational demand of the target computing task, and then further determine, from a GPU hardware integrated into the determined computing node, the first GPU hardware that has remaining computational resources satisfying the computational demand of the target computing task.

If the scheduler determines, from the computing cluster, a plurality of computing nodes that have remaining computational resources satisfying the computational demand of the target computing task, the scheduler can further score the plurality of computing nodes; can evaluate a matching degree of each of the plurality of computing nodes to the target computing task based on the score; can determine a proper computing node for the target computing task from the plurality of computing nodes; and can further determine, from a GPU hardware integrated into the proper computing node, the first GPU hardware that has remaining computational resources satisfying the computational demand of the target computing task.

It should be noted that specific implementation details of scoring the plurality of computing nodes are not described in detail in this specification. For example, the computing cluster is a kubernetes cluster, and each computing node can be scored based on a scoring mechanism of the kubernetes cluster for the computing node.

In one or more shown implementations, to implement precise scheduling of the computational resources of the GPU hardware, the computing node in the computing cluster can further support virtualizing the computational resources of the integrated GPU hardware into a virtual GPU. The virtual GPU can specifically include a first-type virtual GPU configured to execute the first-type computing task and a second-type virtual GPU configured to execute the second-type computing task.

Correspondingly, the remaining status that is of the computational resources of each GPU hardware in the computing cluster and that is maintained by the scheduler can be specifically a first remaining computational capacity and a second remaining computational capacity that correspond to each GPU hardware in the computing cluster, the first remaining computational capacity can represent a quantity of first-type virtual GPUs that are capable of being created based on the remaining computational resources of the GPU hardware, and the second remaining computational capacity can represent a quantity of second-type virtual GPUs that are capable of being created based on the remaining computational resources of the GPU hardware.

For example, in an example, to facilitate fine management of the computational resources of the GPU hardware, by default, computational resources of one GPU hardware can be abstracted into 100 parts by percentage. For example, by default, computational resources of a GPU hardware can be abstracted into 100 first-type virtual GPUs and 100 second-type virtual GPUs. It should be noted that, that the computational resources of the GPU hardware are abstracted into 100 first-type virtual GPUs and 100 second-type virtual GPUs means a quantity of first-type virtual GPUs and a quantity of second-type virtual GPUs can be separately created when all the computational resources of the GPU hardware are in an idle state. If the remaining computational resources of the GPU changes, a quantity of first-type virtual GPUs and a quantity of second-type virtual GPUs into which the remaining computational resources of the GPU hardware can be abstracted usually also changes.

In this case, if the target computing task is the first-type computing task, when the scheduler determines, from the computing cluster, the first GPU hardware that has remaining computational resources satisfying the computational demand of the target computing task, the scheduler can specifically determine, from the computing cluster based on the first remaining computational capacity (that is, a quantity of first-type virtual GPUs that can be created based on the remaining computational resources) corresponding to each GPU hardware in the computing cluster, a GPU hardware that has first remaining computational capacity satisfying a first demand of the target computing task for the first-type virtual GPU, and then use the determined GPU hardware as the first GPU hardware that has remaining computational resources satisfying the computational demand of the target computing task.

It should be noted that, in actual applications, the first GPU hardware can be one independent GPU hardware, or can be a plurality of GPU hardwares. This is not specifically limited in this specification.

For example, if a computational demand of the target computing task does not exceed computational resources of one independent GPU hardware, when scheduling the target computing task, the scheduler can schedule, by default for running, the target computing task to one independent GPU hardware that has remaining computational resources satisfying the computational demand of the target computing task in the computing cluster. If the computational demand of the target computing task is relatively large and exceeds the computational resources of one independent GPU hardware, when scheduling the target computing task, the scheduler may need to schedule the target computing task to a plurality of GPU hardwares that have remaining computational resources satisfying the computational demand of the target computing task in the computing cluster.

It should be further noted that the first remaining computational capacity and the second remaining computational capacity that correspond to each GPU hardware in the computing cluster and that is maintained by the scheduler are usually the quantity of first-type virtual GPUS and the quantity of second-type virtual GPUs that are estimated to be created based on the remaining computational resources of each GPU hardware in the computing cluster. Actually, virtualization processing may not be completed for each GPU hardware in the computing cluster. That is, before a computing task is scheduled to each GPU hardware in the computing cluster, each GPU hardware in the computing cluster does not need to virtualized in advance, and instead, virtualization processing of the GPU hardware can be triggered after the computing task is scheduled to one GPU hardware in the computing cluster.

In one or more shown implementations, the first remaining computational capacity and the second remaining computational capacity that correspond to each GPU hardware in the computing cluster and that are maintained by the scheduler can be specifically remaining amounts that are obtained by the scheduler by locally updating, in real time, an initial value of the first remaining computational capacity and an initial value of the second remaining computational capacity that are reported when each computing node in the computing cluster joins the computing cluster.

In this case, when joining the computing cluster, each computing node in the computing cluster can report, to the scheduler, the initial value of the first remaining computational capacity and the initial value of the second remaining computational capacity that correspond to each integrated GPU hardware, namely, a maximum quantity of first-type virtual GPUs and a maximum quantity of second-type virtual GPUs that can be created when all the computational resources of the integrated GPU hardware are in an idle state.

After obtaining the initial value of the first remaining computational capacity and the initial value of the second remaining computational capacity that are reported by each computing node in the computing cluster when joining the computing cluster, the scheduler can locally maintain the obtained initial value of the first remaining computational capacity and the obtained initial value of the second remaining computational capacity. Subsequently, after scheduling, to any GPU hardware in the computing cluster, the first-type computing task or the second-type computing task that is created in the computing cluster, the maintained initial value of the first remaining computational capacity or the maintained initial value that corresponds to the second remaining computational capacity of the GPU hardware can be updated based on a quantity of first-type computing tasks or a quantity of second-type computing tasks that are occupied by the first-type computing task or the second-type computing task.

In one or more other shown implementations, the first remaining computational capacity and the second remaining computational capacity that correspond to each GPU hardware in the computing cluster and that are maintained by the scheduler can be specifically remaining amounts that are reported by each computing node in the computing cluster in real time.

In this case, each computing node in the computing cluster can locally maintain the initial value of the first remaining computational capacity and the initial value of the second remaining computational capacity that correspond to each integrated GPU hardware; based on a quantity of first-type virtual GPUs or the second-type virtual GPUs occupied by the first-type computing task or the second-type computing task that is scheduled, for running, to the GPU hardware integrated into the computing node, can update, in real time, the initial value of the first remaining computational capacity and the initial value of the second remaining computational capacity that are locally maintained; and can report, in real time to the scheduler, the updated first remaining computational capacity and the updated second remaining computational capacity, so that the scheduler performs local maintenance.

In this specification, the scheduler can further schedule the target computing task to the first GPU hardware for running after determining, for the target computing task from the computing cluster with reference to the maintained remaining status of the computational resources of each GPU hardware, the first GPU hardware that has remaining computational resources satisfying the computational demand of the target computing task.

In one or more shown implementations, when scheduling the target computing task to the first GPU hardware in the computing cluster for running, the scheduler can specifically send the first demand of the target computing task for the first-type virtual GPU and a hardware identifier of the first GPU hardware to the first computing node. The first computing node is a computing node integrated with the first GPU hardware in the computing cluster.

After receiving the first demand of the target computing task for the first-type virtual GPU and the hardware identifier of the first GPU hardware, the first computing node can virtualize the first GPU hardware based on a demand of the target computing task for the computational resources, to obtain several first-type virtual GPUs corresponding to the first demand of the target computing task for the first-type virtual GPU, and then, can run the target computing task based on the virtualized several first-type virtual GPUs. For example, if the first demand of the target computing task for the first-type virtual GPU is N, N first-type virtual GPUs can be virtualized based on a demand.

Certainly, in actual applications, a specific GPU hardware can be virtualized in advance, in addition to being virtualized based on a demand, for computational resources, of a computing task scheduled to the GPU hardware. After the computing task is scheduled to the GPU hardware, a needed virtual GPU can be allocated to the computing task from a virtual GPU obtained by virtualizing the GPU hardware in advance.

A detailed process of virtualizing the GPU hardware is not described in detail in this specification. A person skilled in the art can refer to a record in a related technology.

For example, the computing cluster is a kubernetes cluster. In the kubernetes cluster, if a computing node in the cluster is integrated with a GPU, and the computing node supports virtualizing computational resources of the GPU into a virtual GPU for use by a containerized application, a GPU virtualization driver module is usually implemented on the computing node for a GPU hardware integrated into the computing node, and the GPU virtualization driver module is used to virtualize the GPU hardware integrated into the computing node.

In one or more shown implementations, the scheduler can further maintain a global topology corresponding to all the computing nodes in the computing cluster, and the global topology can be specifically a topology including topology information reported by all the computing nodes in the computing cluster.

For example, in actual applications, after joining the computing cluster, all computing nodes in the computing cluster can report topology information to the scheduler, and the scheduler can integrate the topology information reported by all the computing nodes, to generate a global topology that can describe a topology relationship between GPU hardwares integrated into all computing nodes in the entire computing cluster.

When sending the first demand of the target computing task for the first-type virtual GPU and the hardware identifier of the first GPU hardware to the first computing node integrated with the first GPU hardware, the scheduler can query the global topology to determine the first computing node integrated with the first GPU hardware, and then send the first demand of the target computing task for the first-type virtual GPU and the hardware identifier of the first GPU hardware to the first computing node.

For example, in actual applications, the global topology can specifically include a correspondence between the node identifier of each computing node in the computing cluster and the hardware identifier of the GPU hardware integrated into each computing node. In addition, the global topology can further include network connection information (for example, RDMA connection information and NVLINK connection information) between the scheduler and each computing node in the computing cluster.

In this case, when sending the first demand of the target computing task for the first-type virtual GPU and the hardware identifier of the first GPU hardware to the first computing node integrated with the first GPU hardware, the scheduler can first query the correspondence included in the global topology to determine the node identifier of the first computing node corresponding to the hardware identifier of the first GPU hardware.

After the node identifier of the first computing node is determined, the network connection information included in the global topology can be further queried, and then, based on the found network connection information, the first demand of the target computing task for the first-type virtual GPU and the hardware identifier of the first GPU hardware are sent to the first computing node.

Step 106: In response to a first indication reported by the first computing node that performs integration, reschedule, to a second GPU hardware in the computing cluster for running, the second-type computing task that is scheduled to the first GPU hardware for running, where the first computing node is a computing node integrated with the first GPU hardware, the first indication is used to indicate that the first-type computing task exclusively occupies computational resources of the first GPU hardware, the first indication is reported by the first computing node to a scheduler when the computational resources of the first GPU hardware that are occupied by the first-type computing task reach a preset threshold, and the second GPU hardware is a GPU hardware that has remaining computational resources satisfying a computational demand of the second-type computing task.

After the scheduler schedules the target computing task to the first GPU hardware determined from the computing cluster, the first computing node integrated with the first GPU hardware can run the target computing task on the integrated first GPU hardware.

For example, as described above, the first computing node can virtualize the first GPU hardware based on the demand of the target computing task for the computational resources, to obtain several first-type virtual GPUs corresponding to the first demand of the target computing task for the first-type virtual GPU, and then, can run the target computing task based on the virtualized several first-type virtual GPUs.

In addition, the first computing node can further monitor, in real time, the computational resources of the first GPU hardware that are occupied by the first-type computing task running on the first GPU hardware. For example, a monitor can be implemented on the first computing node, and the computational resources of the first GPU hardware that are occupied by the target computing task are monitored by using the monitor.

It should be noted that in actual applications, in a process in which the first computing node monitors the computational resources of the first GPU hardware that are occupied by the first-type computing task running on the first GPU hardware, occupation of the computational resources of the first GPU hardware by the first-type computing task can be specifically learned of by monitoring a numerical change of a computing power index related to the computational resources of the first GPU hardware. The computing power index can specifically include any form of index that can describe occupation of the computational resources of the first GPU hardware by the target computing task.

Then, the first computing node can further determine, based on a value change of these monitored computing power indexes, whether the computational resources of the first GPU hardware that are occupied by the first-type computing task reach the preset threshold.

In one or more shown implementations, the computing power index can specifically include one or a combination of a plurality of indexes in indexes such as response duration of a request related to the target computing task, utilization of the first GPU hardware, and utilization of graphics memory of the first GPU hardware. However, the first computing node can determine whether a value of the monitored computing power index reaches the preset threshold, to determine that the computational resources of the first GPU hardware that are occupied by the first-type computing task reach the preset threshold.

Certainly, in actual applications, in addition to the listed indexes, the computing power indexes can further include another type of index that can describe occupation of the first GPU hardware by the computational resources of the target computing task. The indexes are not listed one by one in this specification.

If the first computing node determines that the computational resources of the first GPU hardware that are occupied by the first-type computing task reach the preset threshold, because the first-type computing task is a computing task with a relatively high service level, the first computing node can report a first indication to the scheduler. The first indication can be used to indicate that the first-type computing task exclusively occupies the computational resources of the first GPU hardware.

For example, an evictor can be implemented on the first computing node, and the evictor can detect a monitoring result, of the monitor implemented on the first computing node, for the computational resources of the first GPU hardware that are occupied by the first-type computing task. When the evictor detects, from the monitor, that the computational resources of the first GPU hardware that are occupied by the first-type computing task reach the preset threshold, a procedure of evicting the second-type computing task scheduled to the first GPU hardware for running can be started, to interrupt running of the second pod on the first GPU hardware, and release computational resources of the first GPU hardware that are occupied by the second pod. Then, the first computing node can further report, to the scheduler, a first indication indicating that the first-type computing task exclusively occupies the computational resources of the first GPU hardware, to indicate that the scheduler no longer schedules the second-type computing task to the first GPU hardware.

After receiving the first indication reported by the first computing node, the scheduler may reschedule, in response to the first indication to the second GPU hardware in the computing cluster for running, the second-type computing task that is scheduled to the first GPU hardware for running.

In one or more shown implementations, the second GPU hardware can be specifically a GPU hardware that is integrated into the first computing node, that is in remaining GPU hardwares other than the first GPU hardware, and that has remaining computational resources satisfying the computational demand of the second-type computing task scheduled to the first GPU hardware for running. Alternatively, the second GPU hardware can be a GPU hardware that is in a GPU hardware integrated into another computing node different from the first computing node integrated with the first GPU hardware in the computing cluster and that has remaining computational resources satisfying the computational demand of the second-type computing task that is scheduled to the first GPU hardware for running.

In this case, when rescheduling, for running to the second-type GPU hardware that has remaining computational resources satisfying the computational demand of the second-type computing task, the second-type computing task that is scheduled to the first GPU hardware for running, whether a second GPU hardware that has remaining computational resources satisfying the computational demand of the second-type computing task that is scheduled to the first GPU hardware for running exists in another GPU hardware that is different from the first GPU hardware and that is integrated into the first computing node can be first determined.

If a second GPU hardware that has remaining computational resources satisfying the computational demand of the second-type computing task that is scheduled to the first GPU hardware for running exists in another GPU hardware that is different from the first GPU hardware and that is integrated into the first computing node, the second-type computing task can be rescheduled in the first computing node, and the second-type computing task is further scheduled, for running, to the second GPU hardware integrated into the first computing node.

In addition, if no second GPU hardware that has remaining computational resources satisfying the computational demand of the second-type computing task that is scheduled to the first GPU hardware for running exists in another GPU hardware that is different from the first GPU hardware and that is integrated into the first computing node, the scheduler can further determine whether a second GPU hardware that has remaining computational resources satisfying the computational demand of the second-type computing task exists in a GPU hardware integrated into another computing node different from the first computing node in the computing cluster. If a second GPU hardware that has remaining computational resources satisfying the computational demand of the second-type computing task exists in the GPU hardware integrated into the another computing node different from the first computing node in the computing cluster, the second-type computing task is further scheduled, for running, to the second GPU hardware integrated into the another computing node.

In this manner, the second-type computing task running on the first GPU hardware can be prevented, as much as possible, from being rescheduled across nodes.

For a specific process in which the scheduler reschedules, to the second GPU hardware, the second-type computing task that is scheduled to the first GPU hardware for running, references can be made to a specific process in which the scheduler schedules the target computing task to the first GPU hardware. Details are omitted for simplicity in this specification.

The above-mentioned embodiment describes, in detail from a perspective of the first computing node, a specific process of rescheduling, to the another second GPU hardware in the computing cluster for running, the second-type computing task running on the first computing node. It should be emphasized that, in actual applications, for any computing node in the computing cluster, if computational resources of the GPU hardware that are occupied by a first-type computing task running on a specific GPU hardware integrated into the computing node reach a preset threshold, the first indication can be reported to the scheduler in the same manner as the first computing node, and the scheduler reschedules, to another GPU hardware in the cluster for running, a second-type computing task running on the computing node. Examples are not listed one by one in this specification.

In one or more shown implementations, after the scheduler determines the task type of the target computing task, if the target computing task is the second-type computing task, the scheduler can also determine, for the target computing task from each physical GPU hardware that is not exclusively occupied in the computing cluster with reference to the maintained remaining status of the computational resources of each GPU hardware, the third GPU hardware that has remaining computational resources satisfying the computational demand of the target computing task.

For example, in actual applications, with reference to the maintained remaining status of the computational resources of each GPU hardware, the scheduler can still specifically determine, from the computing cluster, a computing node integrated with an integrated GPU hardware that is not exclusively occupied by the first-type computing task and that has remaining computational resources satisfying the computational demand of the target computing task, and then further determine, from a GPU hardware that is integrated into the determined computing node and that is not exclusively occupied by the first-type computing task, the third GPU hardware that has remaining computational resources satisfying the computational demand of the target computing task.

If the scheduler determines, from the computing cluster, a plurality of computing nodes integrated with GPU hardwares that is not exclusively occupied by the first-type computing task and that have remaining computational resources satisfying the computational demand of the target computing task, the scheduler can still score the plurality of computing nodes; can evaluate a matching degree of each of the plurality of computing nodes to the target computing task based on the score; can determine a proper computing node for the target computing task from the plurality of computing nodes; and can further determine, from a GPU hardware that is integrated into the proper computing node and that is not exclusively occupied by the first-type computing task, the third GPU hardware that has remaining computational resources satisfying the computational demand of the target computing task.

In one or more shown implementations, the remaining status that is of the computational resources of each GPU hardware in the computing cluster and that is maintained by the scheduler can also be specifically a first remaining computational capacity and a second remaining computational capacity that correspond to each GPU hardware in the computing cluster, the first remaining computational capacity can represent a quantity of first-type virtual GPUs that are capable of being created based on the remaining computational resources of the GPU hardware, and the second remaining computational capacity can represent a quantity of second-type virtual GPUs that are capable of being created based on the remaining computational resources of the GPU hardware.

In this case, if the target computing task is the second-type computing task, when the scheduler determines, from the computing cluster, the third GPU hardware that is not exclusively occupied by the first-type computing task and that has remaining computational resources satisfying the computational demand of the target computing task, the scheduler can specifically determine, from all physical GPU hardwares that are not exclusively occupied by the first-type computing task in the computing cluster based on the second remaining computational capacity (that is, a quantity of second-type virtual GPUs that can be created based on the remaining computational resources) corresponding to each GPU hardware in the computing cluster, a GPU hardware that has second remaining computational capacity satisfying a second demand of the target computing task for the second-type virtual GPU, and then use the determined GPU hardware as the third GPU hardware that has remaining computational resources satisfying the computational demand of the target computing task.

It should be noted that, in actual applications, the third GPU hardware can be specifically one independent GPU hardware, or can be a plurality of GPU hardwares. This is not specifically limited in this specification.

In this specification, the scheduler can further schedule the target computing task to the third GPU hardware for running after determining, for the target computing task from all the physical GPU hardwares that are not exclusively occupied by the first-type computing task in the computing cluster with reference to the maintained remaining status of the computational resources of each GPU hardware, the third GPU hardware that has remaining computational resources satisfying the computational demand of the target computing task.

In one or more shown implementations, when scheduling the target computing task to the third GPU hardware in the computing cluster for running, the scheduler can specifically send the second of the target computing task for the second-type virtual GPU and a second hardware identifier of the third GPU hardware to the second computing node. The second computing node is a computing node integrated with the third GPU hardware in the computing cluster.

After receiving the second demand of the target computing task for the second-type virtual GPU and the hardware identifier of the third GPU hardware, the second computing node can virtualize the third GPU hardware based on a demand of the target computing task for the computational resources, to obtain several second-type virtual GPUs corresponding to the second demand of the target computing task for the second-type virtual GPU, and then, can run the target computing task based on the virtualized several second-type virtual GPUs.

In one or more shown implementations, the scheduler can further maintain a global topology corresponding to all the computing nodes in the computing cluster. When sending the second demand of the target computing task for the second-type virtual GPU and the hardware identifier of the third GPU hardware to the first computing node integrated with the first GPU hardware, the scheduler can query the global topology corresponding to all the GPU hardwares in the computing cluster to determine the second computing node integrated with the third GPU hardware, and then send the second demand of the target computing task for the second-type virtual GPU and the hardware identifier of the third GPU hardware to the second computing node.

The second computing node integrated with the third GPU hardware is determined by querying the global topology, and then the second demand of the target computing task for the second-type virtual GPU and the hardware identifier of the third GPU hardware are sent to the second computing node. Details are omitted for simplicity.

In one or more shown implementations, the scheduler can maintain a hardware mode corresponding to each GPU hardware in the computing cluster in addition to maintaining a remaining state of computational resources of each GPU hardware in the computing cluster.

The hardware mode can include a resource sharing mode and a resource exclusive mode.

The resource sharing mode indicates that computational resources of the GPU hardware support running of a plurality of types of computing tasks, and the resource exclusive mode indicates that the computational resources of the GPU hardware are only used to execute the first-type computing task. By default, the hardware mode of each GPU hardware in the computing cluster can be the resource sharing mode, to indicate that the computational resources of the GPU hardware can support running of a plurality of types of computing tasks.

After receiving the first indication reported by a specific computing node, the scheduler can switch the GPU hardware from the resource sharing mode to the resource exclusive mode. For example, after receiving the first indication reported by the first computing node, the scheduler can switch the first GPU hardware from the resource sharing mode to the resource exclusive mode in response to the first indication.

In one case, only the GPU hardware in the resource sharing mode supports running of the second-type computing task. Therefore, when determining, from the GPU hardware in the computing cluster, the GPU hardware that has remaining computational resources satisfying the computational demand of the second-type computing task for the second-type computing task, the scheduler needs to consider a specific mode of the GPU hardware in the computing cluster.

In this case, the scheduler can determine, for the second-type computing task, the GPU hardware that has remaining computational resources satisfying the computational demand of the second-type computing task from the GPU hardware in the resource sharing mode in the computing cluster. For example, if the target computing task is the second-type computing task, the target computing task can be scheduled, for running, to the third GPU hardware that is in the resource sharing mode in the computing cluster and that has remaining computational resources satisfying the computational demand of the target computing task.

In another case, both a GPU hardware in the resource sharing mode and a GPU hardware in the resource exclusive mode can support running of the first-type computing task. Therefore, when determining, from the GPU hardware in the computing cluster, the GPU hardware that has remaining computational resources satisfying the computational demand of the first-type computing task for the first-type computing task, the scheduler does not need to consider the hardware mode of the GPU hardware in the computing cluster. That is, the GPU hardware that has remaining computational resources satisfying the computational demand of the first-type computing task only needs to be determined from the GPU hardware in the resource sharing mode and the resource exclusive mode in the computing cluster for the first-type computing task.

In one or more shown implementations, the computing node in the cluster can further report a second indication to the scheduler when determining that the computational resources of the GPU hardware that are occupied by the first-type computing task running on the GPU hardware integrated into the computing node are less than a preset threshold. After receiving a second indication reported by a computing node, the scheduler can switch the GPU hardware from the resource exclusive mode to the resource sharing mode in response to the second indication.

For example, if the target computing task is the first-type computing task, after the first-type computing task is scheduled to the first GPU hardware in the computing cluster for running, after receiving the second indication reported by the first computing node integrated with the first GPU hardware, the scheduler can switch the first GPU hardware from the resource exclusive mode to the resource sharing mode.

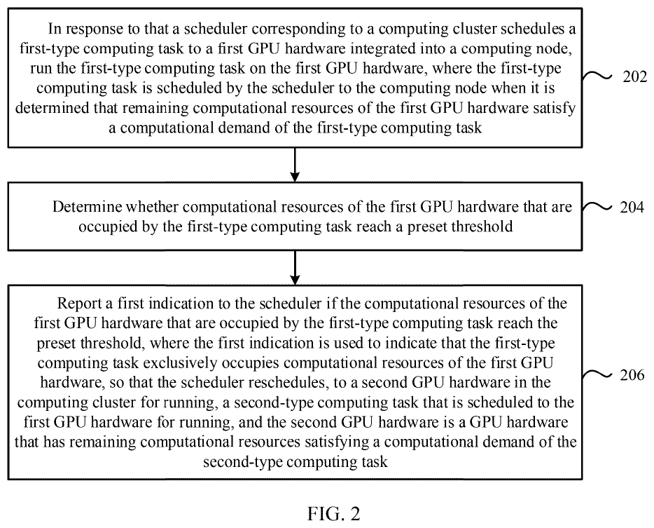

FIG. 2 is a flowchart illustrating another GPU computational resource scheduling method, according to this specification. The method is applied to any computing node in a computing cluster. At least some computing nodes in the computing cluster are integrated with at least one GPU hardware, the computing node supports running of a plurality of types of computing tasks on a same integrated GPU hardware, the plurality of types of computing tasks include a first-type computing task and a second-type computing task, a service level of the first-type computing task is higher than that of the second-type computing task, and the method includes the following execution process.

Step 202: In response to that a scheduler corresponding to the computing cluster schedules the first-type computing task to a first GPU hardware integrated into the computing node, run the first-type computing task on the first GPU hardware, where the first-type computing task is scheduled by the scheduler to the computing node when it is determined that remaining computational resources of the first GPU hardware satisfy a computational demand of the first-type computing task.

Step 204: Determine whether computational resources of the first GPU hardware that are occupied by the first-type computing task reach a preset threshold

Step 206: Report a first indication to the scheduler if the computational resources of the first GPU hardware that are occupied by the first-type computing task reach the preset threshold, where the first indication is used to indicate that the first-type computing task exclusively occupies computational resources of the first GPU hardware, so that the scheduler reschedules, to a second GPU hardware in the computing cluster for running, the second-type computing task that is scheduled to the first GPU hardware for running, and the second GPU hardware is a GPU hardware that has remaining computational resources satisfying a computational demand of the second-type computing task.

It should be noted that the above-mentioned descriptions are specific embodiments provided from a perspective of a computing node in the computing cluster. Specific implementation details in this embodiment are the same as those disclosed in the embodiment shown in FIG. 1. Details are omitted for simplicity in this specification.

The following describes the above-mentioned technical solutions in detail by using an example in which the computing cluster as a kubernetes cluster.

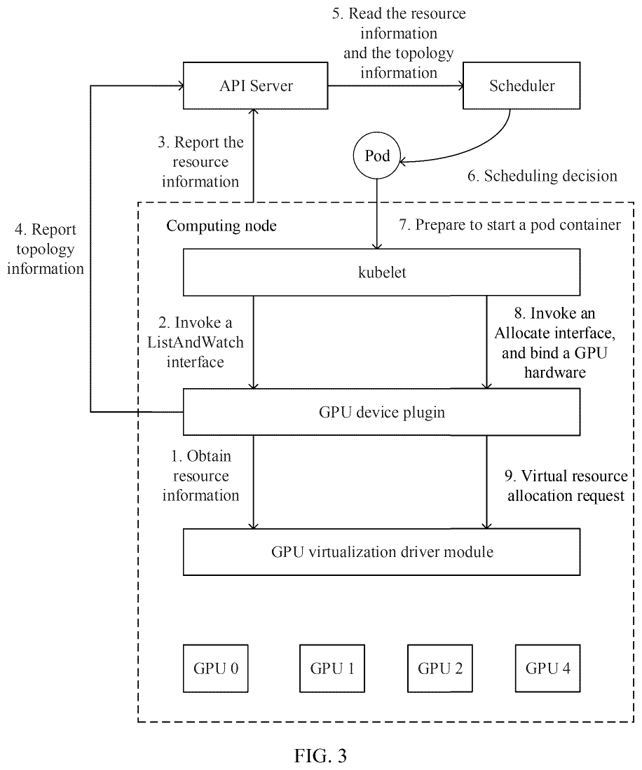

FIG. 3 is a schematic diagram illustrating scheduling of computational resources of a GPU hardware integrated into a computing node in a kubernetes cluster, according to this specification.

The first-type computing task in the kubernetes cluster can be specifically a computing task running on a pod that has a QoS service level that is Guaranteed (referred to as a GT task below), and the second-type computing task can be a computing task running on a pod that has a QoS service level that is BestEffort (referred to as a BE task below).

If the computing node in the kubernetes cluster is integrated with a GPU, and the computing node supports virtualizing the computational resources of the GPU into a virtual GPU for use by a containerized application, a plug-in named GPU Device Plugin is usually implemented on the computing node, and the plug-in is mainly used to discover, manage, and schedule computational resources of all GPU hardwares integrated into the computing node. The plug-in serves as a bridge between kubelet (a daemon) on the Kubernetes node and the GPU hardware, so that the GPU resources can be transparently used by the pod in the Kubernetes cluster in a resource request manner. In addition, each computing node can further implement a GPU virtualization driver module. The GPU virtualization driver module can be specifically configured to virtualize the GPU hardware integrated into the computing node.

When a computing node (for example, a physical machine or a virtual machine) joins the kubernetes cluster, to facilitate fine management on computational resources of a physical GPU hardware integrated into the computing node, the GPU virtualization driver module implemented on the computing node can abstract the remaining computational resources of each GPU hardware into 100 parts of GT resources (that is, the above-mentioned first remaining computational capacity) and 100 parts of BE resources (that is, the above-mentioned second remaining computational capacity) by percentage. It should be noted that the GT resources represent a first-type virtual GPU used to execute a GT task, and BE resources represent a second-type virtual GPU used to execute a BE task.

As shown in FIG. 3, the plug-in GPU Device Plugin implemented on the computing node detects a GPU model and a quantity of GPU hardwares integrated into the computing node at startup; obtains, from the GPU virtualization driver module, GT resources and BE resources that are abstracted based on the remaining computational resources of the GPU hardware; and caches the GT resources and the BE resources in the plug-in as resource information of the computing node. For example, the hardware identifier of each physical GPU can be associated with the quantity of GT resources and the quantity of BE resources abstracted from each physical GPU, which are cached inside Device Plugin plug-in of the GPU.

Still as shown in FIG. 3, the plug-in GPU Device Plugin can further externally expose a ListAndWatch interface. After the computing node joins the kubernetes cluster, the Kubelet daemon on the computing node can invoke a ListAndWatch interface to obtain resource information that is of the computing node and that is cached in a data structure inside the plug-in GPU Device Plugin, and then report the obtained resource information of the computing node to the API server of the kubernetes cluster. The API server is a core component in the Kubernetes cluster, and is an entrance to cluster control.

Still as shown in FIG. 3, when the computing node joins the kubernetes cluster, the plug-in GPU Device Plugin can further collect topology information of the GPU hardware integrated into the computing node, and then report the collected topology information to the API server. For example, the collected topology information can be encapsulated into a device data object, and reported to the API server.

The topology information can specifically include a correspondence between the node identifier of each computing node in the computing cluster and the hardware identifier of the GPU hardware integrated into each computing node. In addition, the topology information can further include network connection information (for example, RDMA connection information used between the scheduler and each computing node) between the scheduler and each computing node in the computing cluster, and network connection information (for example, NVLINK connection information between all GPU hardwares) between the GPU hardwares integrated into all computing nodes in the computing cluster.

Still as shown in FIG. 3, after the computing node joins the kubernetes cluster, the scheduler of the kubernetes cluster can read, from the API server, resource information of the computing node (that is, a quantity of GT resources and a quantity of BE resources of the computing node) and topology information of GPU hardware integrated into the computing node, and cache the read information into the scheduler for reference for subsequent task scheduling.

Still as shown in FIG. 3, after a user creates, based on a specific computing demand, a first pod that is used to execute a GT task in the kubernetes cluster, the scheduler can first determine the demand of the first pod for the GT resources. For example, the demand of the first pod for the GT resources can usually include a quantity of occupied GPU hardwares and a quantity of GT resources that need to be used on each GPU hardware.

After determining the demand of the first pod for the GT resources, the scheduler can perform a scheduling decision on the first pod based on the cached resource information of each computing node in the kubernetes cluster.

Specifically, the scheduler can traverse the cached resource information of each computing node in the kubernetes cluster, and select a computing node integrated with a GPU hardware that has a quantity of parts of remaining GT resources satisfying the demand of the first pod for the GT resources.

If no computing node in the kubernetes cluster satisfies the demand of the first pod for the GT resources, a current round of scheduling is exited, and it is marked as “the first pod is unsuccessfully scheduled”. If a plurality of computing nodes in the kubernetes cluster satisfy the demand of the first pod for the GT resources, the scheduler can further score each computing node based on a scoring mechanism of the computing node in the kubernetes cluster, and evaluate, based on the score, a matching degree of each computing node in the plurality of computing nodes for the GT task executed by the first pod, so that a proper first computing node can be determined for the GT task from the plurality of computing nodes, and then a first GPU hardware that has a quantity of parts of remaining GT resources satisfying the demand of the GT task for the GT resources can be further determined from the GPU hardware integrated into the first computing node.

Further, after the scheduler determines that the first GPU hardware that has a quantity of parts of remaining GT resources satisfying the demand of the GT task for the GT resources, the scheduler completes a scheduling decision for the first pod, and a decision maker can update a scheduling result to the first pod. For example, information such as a hardware identifier of the first GPU hardware allocated to the first pod and a quantity of GT resources that need to be used by the first pod can be updated to an annotations field of the first pod.

After the decision result is updated to the first pod, the decision maker can send the first pod to the determined first computing node based on the maintained topology information, so that the Kubelet daemon of the first computing node prepares to start the pod.

Still as shown in FIG. 3, it is assumed that the first computing node is the newly added computing node of the cluster, and the Kubelet daemon of the first computing node can start to prepare to start the first pod after a scheduling result of the scheduler for the first pod is detected.

Before the first pod is started, the Kubelet daemon of the first computing node can invoke an Allocate interface provided by the plug-in GPU Device Plugin of the first computing node to bind the first pod to the first GPU hardware.

Specifically, the Kubelet daemon of the first computing node can read the scheduling result recorded in the annotations field of the first pod, obtain information such as the hardware identifier of the first GPU hardware allocated to the first pod and the quantity of GT resources that need to be used by the first pod, further invoke the Allocate interface provided by the plug-in GPU Device Plugin of the first computing node to load a corresponding device file for the first pod on the first GPU hardware, bind the first pod to the first GPU hardware, and continue to send a virtual resource allocation request to the GPU virtualization driver module of the first computing node. The virtual resource allocation request can include the quantity of GT resources that need to be used by the first pod, that is, the quantity of first-type virtual GPUs that need to be used.

After receiving the resource allocation request, the GPU virtualization driver module of the first computing node can perform virtualize the first GPU hardware based on the quantity of GT resources that need to be used by the first pod and that is included in the resource allocation request, to obtain several GT resources corresponding to the quantity of GT resources that need to be used by the first pod, and then allocate these GT resources to the first pod.

After GT resources that need to be used are allocated to the first pod, the Kubelet daemon of the first computing node can start the first pod, and run the first pod based on the GT resources allocated to the first pod.

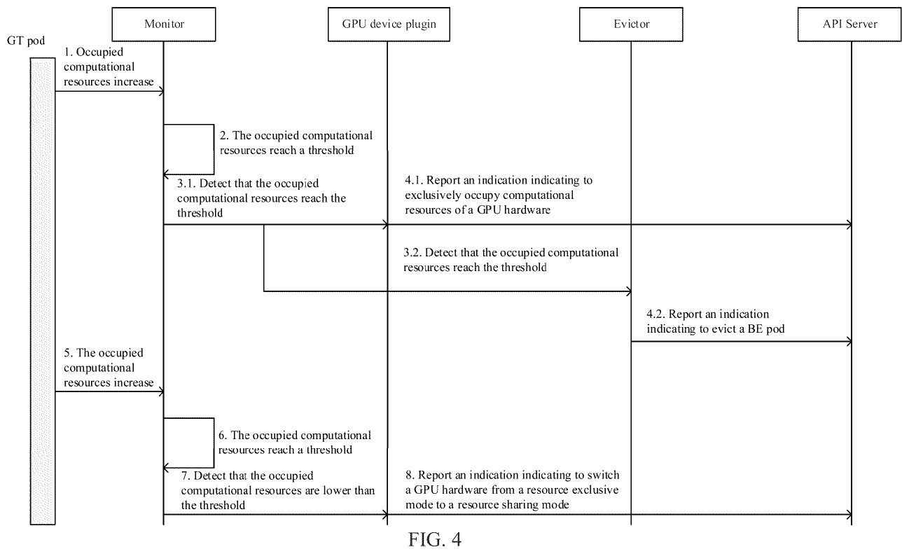

FIG. 4 is a schematic diagram illustrating elastic scheduling of a computing task that is scheduled to a GPU hardware integrated into a computing node and that has a low service level in a kubernetes cluster, according to this specification.

The computing node in the kubernetes cluster can further implement a monitor and an evictor. The monitor can be configured to monitor computational resources of the GPU hardware that are occupied by the pod used to execute the GT task and that are scheduled to the GPU hardware integrated into the computing node. The evictor can be configured to: monitor the monitoring result of the monitor, stop running of the pod on the GPU hardware when it is detected that the computational resources of the GPU hardware that are occupied by the pod used to execute the GT task reach a preset threshold, and release the computational resources of the GPU hardware that are occupied by the pod.

As shown in FIG. 4, after the scheduler schedules, to the first GPU hardware integrated into the first computing node, the first pod used to execute the GT task, the monitor on the first computing node can monitor the computational resources of the first GPU hardware that are occupied by the first pod. The evictor on the first computing node can detect the monitoring result of the monitor. When the computational resources of the first GPU hardware that are occupied by the first pod continuously increase, the evictor detects, from the monitor, that the computational resources of the first GPU hardware that are occupied by the first pod reach a preset threshold. In this case, the evictor can start a procedure of evicting a second pod that is scheduled to the first GPU hardware for running and that is used to execute a BE task, interrupt running of the second pod on the first GPU hardware, release the computational resources of the first GPU hardware that are occupied by the second pod, and report, to the API server of the kubernetes cluster, an indication of evicting the second pod from the first GPU hardware.

A process of interrupting running of the second pod on the first GPU hardware and releasing the computational resources of the first GPU hardware that are occupied by the second pod can be performed after the second pod is rescheduled, or can be performed immediately before the second pod is rescheduled. This is not specifically limited in this embodiment.

In addition, the plug-in GPU Device Plugin of the first computing node can also detect the monitoring result of the monitor. When the plug-in GPU Device Plugin detects, from the monitor, that the computational resources of the first GPU hardware that are occupied by the first pod reach the preset threshold, the plug-in GPU Device Plugin can further report, to the API server of the kubernetes cluster, an indication indicating that the first pod exclusively occupies the computational resources of the first GPU hardware.

The scheduler of the kubernetes cluster can read, from the API server, the indication reported by the first computing node.

When the scheduler reads, from the API server, an indication indicating that the first pod reported by the plug-in GPU Device Plugin on the first computing node exclusively occupies the computational resources of the first GPU hardware, the first GPU hardware can be switched from the resource sharing mode to the resource exclusive mode in response to the indication. Subsequently, the computational resources of the first GPU hardware is not allocated to the pod used to execute the BE task.

In addition, when the scheduler reads, from the API server, the indication that is reported by the evictor on the first computing node and that indicates that the second pod is evicted from the first GPU hardware, the scheduler can start, in response to the indication, a procedure of rescheduling the second pod, to reschedule the second pod to another GPU hardware in the cluster for running.

Certainly, in actual applications, the evictor may not report the indication indicating to evict the second pod from hardware of the first GPU. In this case, the indication that is reported by the plug-in GPU Device Plugin on the first computing node and that indicates that the first pod exclusively occupies the computational resources of the hardware of the first GPU can trigger the scheduler to start a procedure of rescheduling the second pod, in addition to triggering the scheduler to switch the hardware of the first GPU from the resource sharing mode to the resource exclusive mode.

Still as shown in FIG. 4, after a period of time, if the computational resources of the first GPU hardware that are occupied by the first GPU continuously decrease, when the plug-in GPU Device Plugin of the first computing node detects, from the monitor, that the computational resources of the first GPU hardware that are occupied by the first pod are less than a preset threshold, the plug-in GPU Device Plugin of the first computing node can further report, to the API server of the kubernetes cluster, an indication indicating that the first GPU hardware is switched from the resource exclusive mode to the resource sharing mode. After reading, from the API server, the indication reported by the plug-in GPU Device Plugin on the first computing node, the scheduler can switch the first GPU hardware from the resource exclusive mode to the resource sharing mode. In this case, the first GPU hardware is restored to a pod that supports hybrid deployment of the pod used to execute the GT task and the pod used to execute the BE task. Subsequently, the idle computational resources of the first GPU hardware can be allocated to the pod that is used to execute the BE task.

It can be learned from the above-mentioned embodiments that, in a scenario in which the same GPU hardware supports hybrid deployment of the pod used to execute the GT task and the pod used to execute the BE task, elastic scheduling of the pod used to execute the BE task is introduced. In this way, when computational resources of the GPU hardware that are occupied by the GT task running on the GPU hardware reach a preset threshold, the BE task running on the GPU hardware is evicted, to ensure a service level of the GT task running on the GPU hardware. In addition, the BE task running on the GPU hardware can be further scheduled to another GPU hardware, to ensure that the BE task is not interfered with by the GT task and can run normally. In addition, when the computational resources of the GPU hardware that are occupied by the GT task running on the GPU hardware are less than the preset threshold, idle computational resources of the GPU hardware can be allocated to another BE task, so that the pod used to execute the BE task and the pod used to execute the GT task can share the computational resources of the GPU in a more proper manner.

Corresponding to the above-mentioned method embodiments, this specification further provides embodiments of an apparatus, an electronic device, and a storage medium.

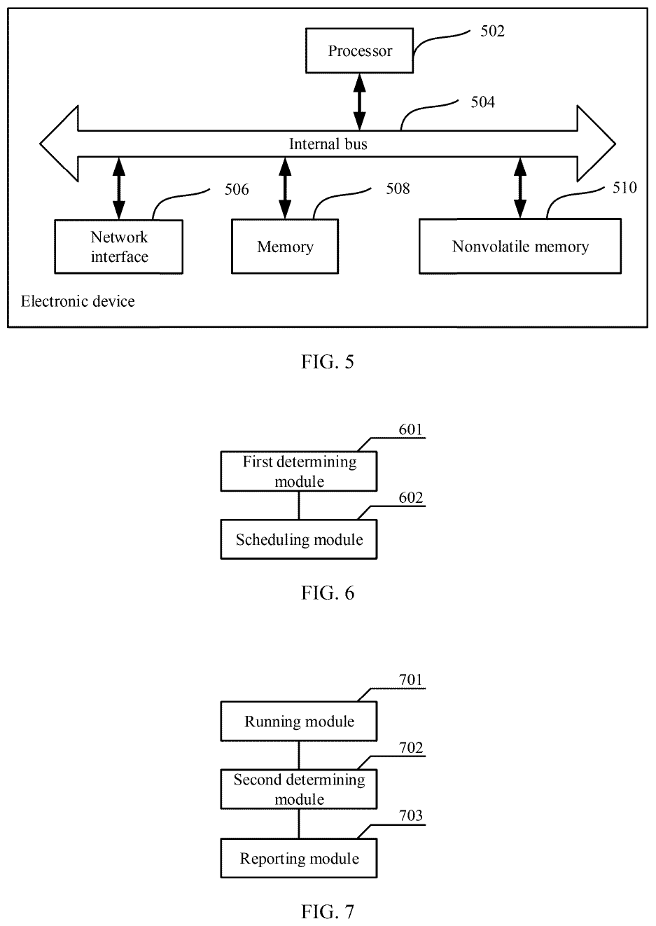

FIG. 5 is a schematic structural diagram illustrating an electronic device, according to one or more example embodiments. As shown in FIG. 5, in terms of hardware, the device includes a processor 502, an internal bus 504, a network interface 506, a memory 508, and a non-volatile memory 510, and certainly may further include other needed hardware. One or more embodiments of this specification can be implemented in a software-based way, for example, the processor 502 reads a corresponding computer program from the non-volatile memory 510 to the memory 508, and then runs the computer program. Certainly, in addition to a software implementation, one or more embodiments of this specification do not exclude another implementation, for example, a logic device or a combination of hardware and software. That is, an execution body of the following processing procedure is not limited to each logical unit, and can also be hardware or a logic device.

FIG. 6 is a block diagram illustrating a GPU computational resource scheduling apparatus, according to one or more example embodiments of this specification. The apparatus can be applied to the electronic device shown in FIG. 5, to implement the technical solutions of this specification. At least some computing nodes in the computing cluster are integrated with at least one GPU hardware, the computing node supports running of a plurality of types of computing tasks on a same integrated GPU hardware, the plurality of types of computing tasks include a first-type computing task and a second-type computing task, a service level of the first-type computing task is higher than that of the second-type computing task, and the apparatus 60 includes: a first determining module 601, configured to: in response to a target computing task created in the computing cluster, determine a task type of the target computing task; and a scheduling module 602, configured to: schedule the target computing task to a first GPU hardware in the computing cluster for running if the target computing task is the first-type computing task, where the first GPU hardware is a GPU hardware that has remaining computational resources satisfying a computational demand of the target computing task; and in response to a first indication reported by a first computing node, reschedule, to a second GPU hardware in the computing cluster for running, the second-type computing task that is scheduled to the first GPU hardware for running, where the first computing node is a computing node integrated with the first GPU hardware, the first indication is used to indicate that the first-type computing task exclusively occupies computational resources of the first GPU hardware, the first indication is reported by the first computing node to the scheduler when computational resources of the first GPU hardware that are occupied by the first-type computing task reach a preset threshold, and the second GPU hardware is GPU hardware that has remaining computational resources satisfying a computational demand of the second-type computing task.

FIG. 7 is a block diagram illustrating another GPU computational resource scheduling apparatus, according to one or more example embodiments of this specification. The apparatus can alternatively be applied to the electronic device shown in FIG. 5, to implement the technical solutions of this specification. At least some computing nodes in the computing cluster are integrated with at least one GPU hardware, the computing node supports running of a plurality of types of computing tasks on a same integrated GPU hardware, the plurality of types of computing tasks include a first-type computing task and a second-type computing task, a service level of the first-type computing task is higher than that of the second-type computing task, and the apparatus 70 includes: a running module 701, configured to: in response to that a scheduler corresponding to the computing cluster schedules the first-type computing task to a first GPU hardware integrated into the computing node, run the first-type computing task on the first GPU hardware, where the first-type computing task is scheduled by the scheduler to the computing node when it is determined that remaining computational resources of the first GPU hardware satisfy a computational demand of the first-type computing task; a second determining module 702, configured to determine whether computational resources of the first GPU hardware that are occupied by the first-type computing task reach a preset threshold; and a reporting module 703, configured to report a first indication to the scheduler if the computational resources of the first GPU hardware that are occupied by the first-type computing task reach the preset threshold, where the first indication is used to indicate that the first-type computing task exclusively occupies computational resources of the first GPU hardware, so that the scheduler reschedules, to a second GPU hardware in the computing cluster for running, the second-type computing task that is scheduled to the first GPU hardware for running, and the second GPU hardware is a GPU hardware that has remaining computational resources satisfying a computational demand of the second-type computing task.

Correspondingly, this specification further provides an electronic device. The electronic device includes: a processor, and a storage configured to store instructions that can be executed by the processor. The processor is configured to implement steps in all the method procedures described above.

Correspondingly, this specification further provides a computer-readable storage medium. The computer-readable storage medium stores executable computer program instructions. When the instructions are executed by a processor, steps in all the method procedures described above are implemented.

Correspondingly, this specification further provides a computer program product. The computer program product stores executable computer program instructions. When the computer program instructions are executed by the processor, steps in all the method procedures described above are implemented.

In the 1990s, whether improvement to a technology is hardware improvement (for example, improvement to a circuit structure like a diode, a transistor, or a switch) or software improvement (improvement to a method procedure) can be clearly identified. However, with development of technologies, improvement to many existing method procedures can be considered as direct improvement to hardware circuit structures. Almost all designers obtain a corresponding hardware circuit structure by programming an improved method procedure into a hardware circuit. Therefore, improvement to a method procedure can be implemented by using a hardware entity module. For example, a programmable logic device (PLD) (for example, a field programmable gate array FPGA)) is such an integrated circuit, and a logical function of the programmable logic device is determined by programming a component by a user. A designer autonomously performs programming to “integrate” a digital system onto a PLD, without requesting a chip manufacturer to design and manufacture a dedicated integrated circuit chip. In addition, currently, instead of manually producing an integrated circuit chip, such programming is usually implemented by using “logic compiler (logic compiler)” software, which is similar to a software compiler used during program development and writing. Original code to be compiled needs to be written in a specific programming language, which is referred to as a hardware description language (HDL). There is not only one HDL, but there are many HDLs such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, and Ruby Hardware Description Language (RHDL). Currently, Very-High-Speed Integrated Circuit Hardware Description Language (VHDL) and Verilog are most commonly used. It should also be clear to a person skilled in the art that a hardware circuit for implementing a logical method procedure can be easily obtained by performing slight logic programming on the method procedure by using the above-mentioned several hardware description languages and programming the method procedure into an integrated circuit.

The controller can be implemented in any suitable manner. For example, the controller can be in a form of a microprocessor or a processor and a computer-readable medium storing computer-readable program code (for example, software or firmware) that can be executed by the (micro) processor, a logic gate, a switch, an application-specific integrated circuit (ASIC), a programmable logic controller, and an embedded microcontroller. Examples of the controller include but are not limited to the following microcontrollers: ARC 625D, Atmel AT91SAM, Microchip PIC18F26K20, and Silicone Labs C2051F320. A storage controller can further be implemented as a part of control logic of a storage. A person skilled in the art also knows that, in addition to implementing the controller by using only computer-readable program code, logic programming can be performed on a method step, so that the controller implements the same function in a form of a logic gate, a switch, an application-specific integrated circuit, a programmable logic controller, an embedded microcontroller, etc. Therefore, the controller can be considered as a hardware component, and an apparatus included in the controller and configured to implement various functions can also be considered as a structure in the hardware component. Alternatively, the apparatus configured to implement various functions can even be considered as both a software module implementing the method and a structure in the hardware component.

The system, apparatus, module, or unit described in the above-mentioned embodiments can be specifically implemented by a computer chip or entity, or can be implemented by a product that has a specific function. A typical implementation device is a server system. Certainly, with development of computer technologies in the future, a computer that implements functions in the above-mentioned embodiments can be, for example, a personal computer, a laptop computer, an on-board human-computer interaction device, a cellular phone, a camera phone, a smartphone, a personal digital assistant, a media player, a navigation device, an email device, a game console, a tablet computer, a wearable device, or any combination of these devices.

Although one or more embodiments of this specification provide the method operation steps illustrated in the embodiments or flowcharts, more or fewer operation steps can be included, based on conventions or non-creative means. A sequence of steps listed in one or more embodiments is merely one of various step execution sequences and does not indicate a sole execution sequence. In practice, when being executed by an apparatus or an end-user device product, the steps can be executed sequentially or in parallel (for example, by parallel processors or in a multi-thread processing environment, or even in a distributed data processing environment) based on the method illustrated in the embodiments or the accompanying drawings. The terms “include”, “contain”, or their any other variants are intended to cover a non-exclusive inclusion, so a process, a method, a product, or a device that includes a list of elements not only includes those elements but also includes other elements which are not expressly listed, or further includes elements inherent to such process, method, product, or device. Without more constraints, the existence of additional identical or equivalent elements in the process, method, product or device that includes the elements is not excluded. For example, if the terms such as “first” and “second” are used to represent names, the terms do not represent any particular order.

For ease of description, the above-mentioned apparatus is described by dividing the apparatus into various modules based on functions. Certainly, during implementation of the one or more embodiments of this specification, the functions of the modules can be implemented in the same one or more pieces of software or hardware or the same combination of one or more pieces of software and hardware, modules implementing the same function can be implemented by using a combination of multiple sub-modules or sub-units, etc. The described apparatus embodiments are merely examples. For example, division into units is merely logical function division and there can be other division methods in actual implementation. For example, a plurality of units or components can be combined or integrated into another system, or some features can be ignored or not performed. In addition, the displayed or discussed mutual couplings or direct couplings or communication connections may be implemented by using some interfaces. The indirect couplings or communication connections between the apparatuses or units may be implemented in electronic, mechanical, or another form.

This application is described with reference to the flowcharts and/or block diagrams of the method, the apparatus (system), and the computer program product according to embodiments of this application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more processes in the flowcharts and/or in one or more blocks in the block diagrams.

These computer program instructions can be stored in a computer-readable storage that can instruct the computer or the another programmable data processing device to work in a specific way, so the instructions stored in the computer-readable storage generate an artifact that includes an instruction apparatus. The instruction apparatus implements a specific function in one or more processes in the flowcharts and/or in one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

In a typical configuration, the computing device includes one or more processors (CPU), input/output interfaces, network interfaces, and memory.

The memory may include a form such as a non-permanent memory, a random access memory (RAM), or a non-volatile memory in a computer-readable medium, for example, a read-only memory (ROM) or a flash memory (flash RAM). The memory is an example of the computer-readable medium.

Computer-readable media, including permanent and non-permanent media or removable and non-removable media, can store information according to any method or technology. Information can be a computer-readable instruction, a data structure, a program module, or other data. Examples of the storage medium of the computer include but are not limited to a phase-change memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disk (DVD) or another optical storage, a magnetic cassette tape, a magnetic disk storage or another magnetic storage device, or any other non-transmission medium, which can be configured to store information accessible to a computing device. As specified in this specification, the computer-readable medium does not include transitory computer-readable media (transitory media), such as a modulated data signal and a carrier.

A person skilled in the art should understand that one or more embodiments of this specification can be provided as a method, a system, or a computer program product. Therefore, one or more embodiments of this specification may take the form of a complete hardware embodiment, a complete software embodiment, or an embodiment incorporating a software and hardware aspect. Furthermore, one or more embodiments of this specification can be used in a form of a computer program product implemented on one or more computer-usable storage media (including but not limited to a disk memory, a CD-ROM, an optical memory, and the like) including computer-usable program code.

The one or more embodiments of this specification can be described in common contexts of computer-executable instructions executed by a computer, such as a program module. Typically, program modules include routines, programs, objects, components, data structures, etc. that perform specific tasks or implement specific abstract data types. One or more embodiments of this specification can alternatively be practiced in distributed computing environments where tasks are performed by remote processing devices that are connected through a communication network. In the distributed computing environment, a program module can be located in local and remote computer storage media including a storage device.

The embodiments of this specification are described in a progressive way. For same or similar parts in the embodiments, reference can be made to each other. Each embodiment focuses on a difference from another embodiment. Particularly, some system embodiments are briefly described because they are basically similar to some method embodiments. For related parts, references can be made to related descriptions in some method embodiments. In the descriptions of this specification, descriptions provided with reference to terms such as “an embodiment”, “some embodiments”, “an example”, “a specific example”, or “some examples” intend to mean that a specific feature, structure, material, or characteristic described with reference to or example is included in at least one embodiment of the embodiments of this specification. In this specification, illustrative expressions of the above-mentioned terms are not necessarily intended for the same embodiment or example. In addition, the described specific feature, structure, material, or characteristic can be combined in a proper way in any one or more embodiments or examples. Moreover, a person skilled in the art can combine and associate different embodiments or examples and features of different embodiments or examples described in this specification, provided that the embodiments or examples and the features do not conflict with each other.

The foregoing descriptions are merely one or more embodiments of this specification and are not intended for limiting the one or more embodiments of this specification. A person skilled in the art knows that one or more embodiments of this specification can have various modifications and changes. Any modification, equivalent replacement, improvement, etc. made without departing from the spirit and principle of this specification shall fall within the scope of the claims.

1. A GPU computational resource scheduling method, comprising:
in response to a target computing task created in a computing cluster corresponding to a scheduler, determining a task type of the target computing task, wherein the computing cluster comprises computing nodes integrated with at least one GPU hardware, wherein the computing nodes support running of a plurality of types of computing tasks on a same integrated GPU hardware, the plurality of types of computing tasks comprise a first-type computing task and a second-type computing task, a service level of the first-type computing task is higher than that of the second-type computing task;
scheduling the target computing task to a first GPU hardware in the computing cluster for running if the target computing task is the first-type computing task, wherein the first GPU hardware has remaining computational resources satisfying a computational demand of the target computing task; and
in response to a first indication reported by a first computing node, rescheduling, to a second GPU hardware in the computing cluster for running the second-type computing task that is scheduled to the first GPU hardware for running, wherein the first computing node is a computing node integrated with the first GPU hardware, the first indication indicates that the first-type computing task exclusively occupies computational resources of the first GPU hardware, the first indication is reported by the first computing node to the scheduler when computational resources of the first GPU hardware occupied by the first-type computing task reach a preset threshold, and the second GPU hardware has remaining computational resources satisfying a computational demand of the second-type computing task.

2. The method according to claim 1, wherein the method further comprises:
scheduling the target computing task to a third GPU hardware in the computing cluster for running if the target computing task is the second-type computing task, wherein the third GPU hardware has computational resources not exclusively occupied by the first-type computing task and has remaining computational resources satisfying the computational demand of the target computing task.

3. The method according to claim 2, wherein the scheduler maintains a hardware mode corresponding to each GPU hardware in the computing cluster, the hardware mode comprises a resource sharing mode and a resource exclusive mode, the resource sharing mode indicates that computational resources of the GPU hardware support running of a plurality of types of computing tasks, and the resource exclusive mode indicates that the computational resources of the GPU hardware are used to execute the first-type computing task.

4. The method according to claim 3, wherein the method further comprises:
switching the first GPU hardware from the resource sharing mode to the resource exclusive mode in response to the first indication reported by the first computing node, wherein the third GPU hardware is a GPU hardware in the resource sharing mode and has remaining computational resources satisfying the computational demand of the target computing task.

5. The method according to claim 4, wherein the method further comprises:
switching the first GPU hardware from the resource exclusive mode to the resource sharing mode in response to a second instruction of the first computing node, wherein the second instruction is reported by the first computing node to the scheduler when the computational resources of the first GPU hardware occupied by the first-type computing task are less than a preset threshold.

6. The method according to claim 1, wherein the computing node supports virtualizing computational resources of an integrated GPU hardware into a virtual GPU, the virtual GPU comprises a first-type virtual GPU configured to execute the first-type computing task and a second-type virtual GPU configured to execute the second-type computing task.

7. The method according to claim 6, wherein the scheduler maintains a first remaining computational capacity and a second remaining computational capacity that correspond to each GPU hardware in the computing cluster, the first remaining computational capacity represents a quantity of first-type virtual GPUs capable of being created based on the remaining computational resources of the GPU hardware, and the second remaining computational capacity represents a quantity of second-type virtual GPUs capable of being created based on the remaining computational resources of the GPU hardware;
the scheduling the target computing task to a first GPU hardware in the computing cluster for running comprises:
determining, from the computing cluster based on the maintained first remaining computational capacity corresponding to each GPU hardware, the first GPU hardware that has first remaining computational capacity satisfying a first demand of the target computing task for the first-type virtual GPU, and scheduling the target computing task to the first GPU hardware in the computing cluster for running; and
the scheduling the target computing task to a third GPU hardware in the computing cluster for running comprises:
determining, from the computing cluster based on the maintained second remaining computational capacity corresponding to each GPU hardware, the third GPU hardware that has computational resources not exclusively occupied by the first-type computing task and that has second remaining computational capacity satisfying a second demand of the target computing task for the second-type virtual GPU, and scheduling the target computing task to the third GPU hardware in the computing cluster for running.

8. The method according to claim 7, wherein the scheduling the target computing task to a first GPU hardware in the computing cluster for running comprises:
sending the first demand of the target computing task for the first-type virtual GPU and a hardware identifier of the first GPU hardware to the first computing node integrated with the first GPU hardware, so that the first computing node virtualizes the first GPU hardware to obtain a plurality of first-type virtual GPUs corresponding to the first demand, and runs the target computing task based on the plurality of first-type virtual GPUs; and
the scheduling the target computing task to a third GPU hardware in the computing cluster for running comprises:
sending the second demand of the target computing task for the second-type virtual GPU and a hardware identifier of the third GPU hardware to a second computing node integrated with the third GPU hardware, so that the second computing node virtualizes the third GPU hardware to obtain a plurality of second-type virtual GPUs corresponding to the second demand, and runs the target computing task based on the plurality of second-type virtual GPUs.

9. The method according to claim 8, wherein the scheduler maintains a global topology corresponding to the computing nodes in the computing cluster, and the global topology comprises topology information reported by the computing nodes in the computing cluster;
the sending the first demand of the target computing task for the first-type virtual GPU and a hardware identifier of the first GPU hardware to the first computing node integrated with the first GPU hardware comprises:
querying the global topology, determining the first computing node integrated with the first GPU hardware, and sending the first demand of the target computing task for the first-type virtual GPU and the hardware identifier of the first GPU hardware to the first computing node; and
the sending the second demand of the target computing task for the second-type virtual GPU and a hardware identifier of the third GPU hardware to a second computing node integrated with the third GPU hardware comprises:
querying the global topology, determining the second computing node integrated with the third GPU hardware, and sending the second demand of the target computing task for the second-type virtual GPU and the hardware identifier of the third GPU hardware to the second computing node.

10. The method according to claim 7, wherein the method further comprises:
obtaining an initial value of the first remaining computational capacity and an initial value of the second remaining computational capacity reported by each computing node in the computing cluster when joining the computing cluster, locally maintaining the obtained initial value of the first remaining computational capacity and the obtained initial value of the second remaining computational capacity, and in response to that the first-type computing task or the second-type computing task that is created in the computing cluster is scheduled to any GPU hardware in the computing cluster, based on a quantity of first-type computing tasks or a quantity of second-type computing tasks occupied by the first-type computing task or the second-type computing task, updating the maintained initial value of the first remaining computational capacity or the maintained initial value of the second remaining computational capacity of the GPU hardware; or
obtaining the first remaining computational capacity and the second remaining computational capacity reported in real time by each computing node in the computing cluster, and locally maintaining the obtained first remaining computational capacity and the obtained second remaining computational capacity, wherein the first remaining computational capacity and the second remaining computational capacity reported in real time by each computing node are obtained by updating an initial value of the first remaining computational capacity and an initial value of the second remaining computational capacity by each computing node based on a quantity of first-type virtual GPUs and a quantity of second-type virtual GPUs occupied by the first-type computing task or the second-type computing task that is scheduled to a GPU hardware integrated into the computing node for running.

11. The method according to claim 1, wherein the second GPU hardware comprises a GPU hardware, other than the first GPU hardware, that is integrated into the first computing node and that has remaining computational resources satisfying the computational demand of the second-type computing task, or the second GPU hardware comprises a GPU hardware that is integrated into another computing node different from the first computing node in the computing cluster and that has remaining computational resources satisfying the computational demand of the second-type computing task; and
the rescheduling, to a second GPU hardware for running, the second-type computing task that is scheduled to the first GPU hardware for running comprises:
determining whether a second GPU hardware that has remaining computational resources satisfying the computational demand of the second-type computing task that is scheduled to the first GPU hardware for running exists in another GPU hardware that is different from the first GPU hardware and that is integrated into the first computing node, and scheduling the second-type computing task to the second GPU hardware for running if the second GPU hardware exists in the another GPU hardware; or
if the second GPU hardware does not exist in the another GPU hardware, determining whether a second GPU that has remaining computational resources satisfying the computational demand of the second-type computing task exists in a GPU hardware integrated into another computing node different from the first computing node in the computing cluster, and scheduling the second-type computing task to the second GPU hardware for running if the second GPU hardware exists.

12. The method according to claim 1, wherein the computing cluster is a kubernetes cluster, the computing node supports hybrid deployment, on a same integrated GPU hardware, of a plurality of containers for running different types of computing tasks, and the computing task is running in a container deployed on each GPU hardware in the kubernetes cluster.

13. The method according to claim 12, wherein the first-type computing task is a computing task running in a container that has a QoS service level being Guaranteed, and the second-type computing task is a computing task running in a container that has a QoS service level that is BestEffort.

14. A GPU computational resource scheduling apparatus, comprising:
at least one processor; and
one or more memories coupled to the at least one processor and storing programming instructions for execution by the at least one processor to perform operations comprising:
in response to a target computing task created in a computing cluster corresponding to a scheduler, determining a task type of the target computing task, wherein the computing cluster comprises computing nodes integrated with at least one GPU hardware, wherein the computing nodes support running of a plurality of types of computing tasks on a same integrated GPU hardware, the plurality of types of computing tasks comprise a first-type computing task and a second-type computing task, a service level of the first-type computing task is higher than that of the second-type computing task;
scheduling the target computing task to a first GPU hardware in the computing cluster for running if the target computing task is the first-type computing task, wherein the first GPU hardware has remaining computational resources satisfying a computational demand of the target computing task; and
in response to a first indication reported by a first computing node, rescheduling, to a second GPU hardware in the computing cluster for running the second-type computing task that is scheduled to the first GPU hardware for running, wherein the first computing node is a computing node integrated with the first GPU hardware, the first indication indicates that the first-type computing task exclusively occupies computational resources of the first GPU hardware, the first indication is reported by the first computing node to the scheduler when computational resources of the first GPU hardware occupied by the first-type computing task reach a preset threshold, and the second GPU hardware has remaining computational resources satisfying a computational demand of the second-type computing task.

15. The apparatus according to claim 14, wherein the operations further comprises:
scheduling the target computing task to a third GPU hardware in the computing cluster for running if the target computing task is the second-type computing task, wherein the third GPU hardware has computational resources not exclusively occupied by the first-type computing task and has remaining computational resources satisfying the computational demand of the target computing task.

16. The apparatus according to claim 15, wherein the scheduler maintains a hardware mode corresponding to each GPU hardware in the computing cluster, the hardware mode comprises a resource sharing mode and a resource exclusive mode, the resource sharing mode indicates that computational resources of the GPU hardware support running of a plurality of types of computing tasks, and the resource exclusive mode indicates that the computational resources of the GPU hardware are used to execute the first-type computing task.

17. The apparatus according to claim 16, wherein the operations further comprise:
switching the first GPU hardware from the resource sharing mode to the resource exclusive mode in response to the first indication reported by the first computing node, wherein the third GPU hardware is a GPU hardware in the resource sharing mode and has remaining computational resources satisfying the computational demand of the target computing task.

18. The apparatus according to claim 17, wherein the operations further comprise:
switching the first GPU hardware from the resource exclusive mode to the resource sharing mode in response to a second instruction of the first computing node, wherein the second instruction is reported by the first computing node to the scheduler when the computational resources of the first GPU hardware occupied by the first-type computing task are less than a preset threshold.

19. The apparatus according to claim 14, wherein the computing node supports virtualizing computational resources of an integrated GPU hardware into a virtual GPU, the virtual GPU comprises a first-type virtual GPU configured to execute the first-type computing task and a second-type virtual GPU configured to execute the second-type computing task.

20. A non-transitory, computer-readable medium storing one or more instructions executable by at least one processor to perform operations comprising:
in response to a target computing task created in a computing cluster corresponding to a scheduler, determining a task type of the target computing task, wherein the computing cluster comprises computing nodes integrated with at least one GPU hardware, wherein the computing nodes support running of a plurality of types of computing tasks on a same integrated GPU hardware, the plurality of types of computing tasks comprise a first-type computing task and a second-type computing task, a service level of the first-type computing task is higher than that of the second-type computing task;
scheduling the target computing task to a first GPU hardware in the computing cluster for running if the target computing task is the first-type computing task, wherein the first GPU hardware has remaining computational resources satisfying a computational demand of the target computing task; and
in response to a first indication reported by a first computing node, rescheduling, to a second GPU hardware in the computing cluster for running the second-type computing task that is scheduled to the first GPU hardware for running, wherein the first computing node is a computing node integrated with the first GPU hardware, the first indication indicates that the first-type computing task exclusively occupies computational resources of the first GPU hardware, the first indication is reported by the first computing node to the scheduler when computational resources of the first GPU hardware occupied by the first-type computing task reach a preset threshold, and the second GPU hardware has remaining computational resources satisfying a computational demand of the second-type computing task.
